(19) United States
(12) Patent Application Publication
(10) Pub. No.: US 2008/0243750 A1
(43) Pub. Date: Oct. 2, 2008

(54) Human Artificial Intelligence Software Application for Machine & Computer Based Program Function

(76) Inventor: Mitchell Kwok, Honolulu, HI (US)

Correspondence Address: Mitchell Kwok, 1675 Kamamalu ave., Honolulu, HI, 96813, US

(21) Appl. No.: 11/936,725

(22) Filed: Nov. 7, 2007

Related U.S. Application Data
(63) Continuation-in-part of application No. 11/770,734, filed on Jun. 29, 2007.
Application No. 11/770,734 is a continuation-in-part of application No. 11/744,767, filed on May 4, 2007.
(60) Provisional application No. 60/909,437, filed on Mar. 31, 2007.

(51) Int. Cl. G06N 7/00; G06F 17/00

(52) U.S. Cl. 706/59

(57) ABSTRACT

A method of creating human artificial intelligence in machines and computer software is presented here, as well as methods to simulate human reasoning, thought and behavior. A new human artificial intelligence software application for machines & computer based program function, which generally comprises computer based software code and programming as well as processes and methods of application, which receives movie sequences from the environment, uses an image processor to generate an initial encapsulated tree, searches for the current pathway in memory and find the best pathway matches, determines the best long-term future pathways, locates an optimal pathway, stores current pathway in optimal pathway, follows the future instructions of optimal pathway, and universalizes data in memory. The present invention further provide users with a software application that will serve as the main intelligence of one or a multitude of computer based programs, software applications, machines or compilation of machinery.

### CROSS REFERENCE TO RELATED APPLICATIONS

This is a Continuation-in-Part application of U.S. Ser. No. 11/770,734 filed on Jun. 29, 2007, which is a Continuation-in-Part application of U.S. Ser. No. 11/744,767, filed on May 4, 2007 both entitled: Human Level Artificial Intelligence Software Application for Machine & Computer Based Program Function, which claims the benefit of U.S. Provisional Application No. 60/909,437, filed on Mar. 31, 2007.

### STATEMENT REGARDING FEDERALLY SPONSORED RESEARCH OR DEVELOPMENT

(Not applicable)

### BACKGROUND OF THE INVENTION

1. Field of the Invention

This invention relates generally to the field of artificial intelligence. Moreover it pertains specifically to human artificial intelligence for machines and computer based software.

2. Description of Related Art

Human artificial intelligence is a term used to describe a machine that can think and feel like a human being. “All fields” in computer science are represented in this technology. Neural networks, planning programs, data mining, rule-based systems, language parsers, genetic programming, discrete math, predicate calculus, semantic networks, Bayesian's probability theories and so forth are all trying to achieve human artificial intelligence. A chain of parent applications has been filed on the present invention to protect certain processes and functions. This patent will cover mainly three topics: the image processor, the search function and representation of language.

Building an image processor to break up image layers in a still picture is a very difficult thing to do. Understanding what pixels belong to what visual objects is hard to delineate. Without intelligence there is no way the AI program will be able to distinguish one image layer from another. In prior art, many image software have been built to solve this problem. Edge detectors, convolution, intensity regions, and line detection are just some of the current image techniques used to dissect imager layers from still pictures. Despite the countless techniques that are being used in the industry, there isn't one image processing software that can cut out image layers from still pictures that equal the intelligence of a human being.

Another problem is the priority of one image layer compared to another. When playing a videogame, sometimes, a small image layer on the screen has higher priority than an image layer that occupies 80 percent of the screen. A bullet for example, the bullet is an image layer that is made up of several pixels. The bullet has top priority over other image layers because the outcome of the videogame depends on the bullet. If the bullet hits the character then the game is over. If the character jumps over the bullet then the game continues.

Another example is a fighting game like Street Fighter or Mortal Kombat. The characters in the game make up less than 10 percent of the entire screen and the background makes up 90 percent of the entire screen. Despite the limited pixels that the characters occupy, the characters have very high priority in terms of what happens during the game. The background has nothing to do with the game so it has low priority. The background can be anything, but it will not interfere with the outcome of the game.

Even if the AI program encounters an image layer thousands and thousands of times that doesn't mean it has high priority. The image layer that changes the future course of a pathway is what gives the image layer its priority. In the case of the Street Fighter game the background can be encountered numerous times, but because the background doesn't change the future pathways of the game, the background will have low priority regardless of how many times the AI program has encountered the background.

Sometimes there are image layers that are hidden or camouflaged in pictures. For example, darkness can hide image layers and it is hard for even intelligent species like human beings to make out image layers. If the robot was in a forest and there was an animal camouflaged in the trees, does the robot know that the tree is actually an animal?

Searching for image layers and movie sequences in very large interconnected networks is another problem. Current search algorithms work well with a few thousand data entries, but when the data entries increase exponentially the search algorithm takes a long time to find information.

Often times, the network has to go through transformations to delete repeated or similar data in order to limit the amount of data entries. However, this quick fix doesn't solve the problem with the search algorithm. A new way to store information and a new way to retrieve information is needed to solve the scaling problem.

The third problem I would like to tackle is representing meaning to language. The ability for machines to understand the “meaning” to language is very difficult to accomplish. In prior art, discrete math and predicate calculus are used to represent language. Predefined iconic objects and rules are used to represent words and grammar structure in a limited environment. Assignment statements, if-then statements, or statements, and statements, not operators and so forth are used in combinations to represent language. They also classify sentences into one of these groups: facts, questions, answers, directed sentences, personal sentences, etc.

To truly understand language is to build a machine very similar to a human being. To instill the machine with the same 5 senses humans have, to build emotions into the machine, to build the machine's body parts very similar to human body parts and so forth. All these senses and functions of the machine will be used to assign meaning to words and sentences for a particular language.

Current language software try to simulate human intelligence by using expert programs to elicit human conversation. These programs work by receiving strings of text from the environment, parsing each word and matching it to certain grammar rules, and searching for the right action or response from a database. Learning new words and learning new meaning to words is a challenge because these type of software don't have the capability of self-learning. Most of the information in the database are manually inserted.

Another fact is that certain words and sentences in English are so complex that there is no meaning. A sentence like: “paper is made from trees”, isn't a sentence that has a meaning. This sentence is actually a logical fact. Many other sentences are encapsulated in this sentence to represent the meaning. We humans need to understand what a paper looks like first and that the atoms that make up the paper is the content that is contained in trees. In order to make paper a tree has to be cut from the forest and processed in a factory. And we also have to know the different types of paper that are available. All these logical and interconnected facts will represent the meaning to: “paper is made from trees”.

This problem is solved by using the robot's conscious to tell the robot what the sentence means. The conscious might activate in the mind, images of trees and paper and machinery or it might activate other sentences telling the robot what the meaning of the sentence is. Either way the conscious will provide the meaning to very complicated sentences.

### SUMMARY OF THE INVENTION

Universal artificial intelligence

This is a software that serves as the foundation for all intelligent machines. Insects, animals and humans contain some kind of universal artificial intelligence that allows them to learn from past experiences and use this past experience to predict the future.

The Universal Artificial Intelligence program is an AI software that can play a videogame in the most optimal way possible. The UAI program serves as the foundation for all learning machines and has a bootstrapping process to keep old information and use the old information to learn new information. This AI program can play all games for any videogame console including X-box 360, Playstation 2, Gameboy advance, P2P and other console based systems.

The function of the UAI program is to pursue pathways that lead to pleasure and stay away from pathways that lead to pain. In terms of the videogame, the AI will play the game by accomplishing the objective of the game with the highest score possible.

The universal artificial intelligence program can also be hooked up to any machine, computer software, or compilation of computer software and behave in an intelligent way. Cars, airplanes, toaster ovens, trucks, buses, tv, houses, robots, computers, search engines, and so forth can be hooked up to the UAI. If the UAI is applied to a car then the car will drive safely from one destination to the next in the safest and quickest way possible. If the UAI is applied to a plane then the plane can fly from one location to the next in the safest and quickest way possible.

Human artificial intelligence

The present invention, also known as the human artificial intelligence program, is derived from UAI. All the functions that make up the UAI are included in the HAI program. An addition is the conscious. The human artificial intelligence program has the ability to learn language and to understand the meaning to language. The conscious also serves many purposes for the robot such as: provide meaning to language, provide facts about a situation or provide information about an object. The human artificial intelligence program is a software that is similar to the human brain.

A chain of parent applications has been filed on the present invention to protect certain processes and functions. This patent will cover mainly three topics: the image processor, the search function and representation of language.

The image processor is designed to break up imager layers in movie sequences in such a way that delineates possible objects. The purpose of the storage network is to further “refine” and “group” these possible objects together and establish the importance of certain objects in a given movie sequence. The important objects will be stronger in memory than the “noise” objects. This is important because the searching for data will greatly depend on the structure of the network.

The image processor generates an initial encapsulated tree so that the input (current pathway) is broken up and grouped in an encapsulated tree in such a manner that all groups in the encapsulated tree are the strongest permutations and combinations of a visual object. The image processor searches for the most important image layers first (even if the image layer is made up of a few pixels) before searching for minor image layers.

Another novel thing about the present invention is the search algorithm used to find image layers and movie sequences. Two search functions are used to find information and they work together to search for information. One uses the top-down search method and the other one uses the bottom-up search method.

There are also 4 different data types to organize and search for information in the network. One special type of search group is called: learned groups. The AI program learns language and uses language to search for information in the network. The scaling problem for data mining can be solved through learned groups. Regardless of how many information is stored in memory, the learned groups will be able to search for information in the fastest and quickest way possible. The learned groups are also used for storing information in the network. The more information is stored in memory the more organized it will become. This helps the search function to find matches in memory.

The AI program will have the ability to represent meaning to language. I define the various data types that are stored in memory. These data types are: 5 sense objects, learned objects, hidden objects and pattern objects. All 4 data types are used in combinations and permutations to assign meaning to language. The rules program will assign certain meaning (objects) to certain words/sentences (objects) based on association. There are two ways two objects can be associated with each other: the more times two objects are trained together and the closer the timing of the two objects are trained the stronger the association.

### BRIEF DESCRIPTION OF THE DRAWINGS

For a more complete understanding of the present invention and for further advantages thereof, reference is now made to the following Description of the Preferred Embodiments taken in conjunction with the accompanying Drawings in which:

FIG. 1 is a software diagram illustrating a program for human artificial intelligence according to an embodiment of the present invention.

FIG. 2 is a diagram depicting how frames are stored in memory.

FIGS. 3A-3B are flow diagrams depicting forgetting data in pathways.

FIGS. 4A-4B are illustrations to demonstrate how 2-demensional movie sequences can be represented in a 3-dimensional way.

FIG. 5 is an illustration to demonstrate priority percents of visual objects.

FIG. 6 is a block diagram to depict the structure of a visual object.

FIG. 7 is an illustration depicting how visual objects are compared.

FIG. 8 is an illustration to demonstrate alternative variations to a visual object.

FIG. 9. is an illustration of the initial encapsulated tree for a current pathway.

FIG. 10 is a diagram depicting an equation to average one variable in one visual object.

FIG. 11 is an illustration depicting the average values of normalized points.

FIG. 12 is an illustration to demonstrate the existence state of visual objects from one frame to the next.

FIG. 13 is an illustration to demonstrate the existence state of learned objects from one frame to the next.

FIG. 14 is an illustration to demonstrate the existence state of pixels or visual objects in a cartoon sequence.

FIG. 15 is a diagram to depict how search points search for a visual object recursively.

FIG. 16A. is a diagram depicting how the first search function finds search areas for visual objects in the initial encapsulated tree.

FIG. 16B. is a diagram depicting the search function limiting multiple copies of a visual object.

FIG. 17 is a diagram to depict the structure of a search point.

FIGS. 18A-18B are diagrams showing the process of how guess points search for matches.

FIG. 18C is a cartoon illustration representing memory objects in FIGS. 18A-18B.

FIG. 19 is a diagram showing the process of a guess point looking for combined visual objects.

FIGS. 20A-20B. are flow diagrams depicting re-organization.

FIGS. 21A-21B. are diagrams depicting self-organization of encapsulated groups between two pathways.

FIG. 22 is a diagram depicting a universal pathway.

FIG. 23 is a diagram showing the hierarchical levels of a universal pathway.

FIGS. 24A-24B are diagrams illustrating self-organization of three object floaters.

FIG. 25 is a diagram showing streaming pathways.

FIG. 26 is an illustration of the range for the taste sense.

FIGS. 27A-27B are diagrams depicting encapsulated objects.

FIG. 28 is a diagram depicting three equal objects.

FIG. 29 is a diagram showing target objects and activated element objects.

FIG. 30 is an illustration of an image layer and the different measurements and distances between encapsulated objects.

FIG. 31 is a diagram showing the 4 different data types: 5 sense objects, hidden objects, learned objects, and pattern objects.

FIGS. 32A-32B are diagrams of how the Al program compare pathways in memory.

FIGS. 33A-33E are flow diagrams depicting the searching of data using visual objects, learned objects and hidden objects.

FIG. 34 is a diagram depicting the ranking of pathway matches.

FIG. 35 is a diagram depicting conscious thought.

FIG. 36 is a diagram depicting 4 equal objects.

FIGS. 37A-38B are diagrams showing how the robot learns different languages.

FIGS. 39A-39C are diagrams showing how the robot modify facts in memory.

### DESCRIPTION OF THE PREFERRED EMBODIMENTS

The Human Artificial Intelligence program acts like a human brain because it stores, retrieve, and modify information similar to human beings. The function of the HAI is to predict the future using the data from memory. For example, human beings can answer questions because they can predict the future. They can anticipate what will eventually happen during an event based on events they learned in the past.

Topics:
1. Overall AI program
2. Image processor
3. Search function
4. Universalize data in memory
5. Representing meaning to language
6. Topics on the robot's conscious

Overall AI program

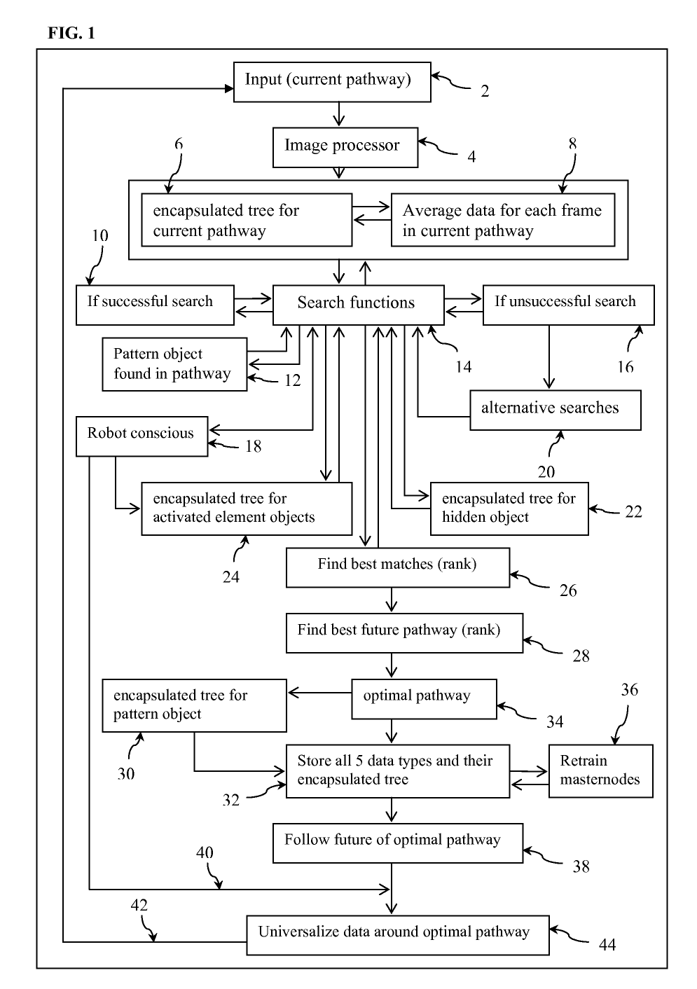

Referring to FIG. 1, the present invention is a method of creating human artificial intelligence in machines and computer based software applications, the method comprising:

an artificial intelligent computer program repeats itself in a single for-loop to receive information, calculate an optimal pathway from memory, and taking action; a storage area to store all data received by said artificial intelligent program; and a long-term memory used by said artificial intelligent program.

Said an AI program repeats itself in a single for-loop to receive information from the environment, calculating an optimal pathway from memory, and taking action. The steps in the for-loop comprises:

1. Receive input from the environment based on the 5 senses and determining the boundaries of the current pathway (block 2).

2. Use the image processor to dissect the current pathway into sections called partial data. For visual objects, dissect data using the 5 functions: dissect moving image layers from frame to frame, dissect partially moving image layers, dissect image layers using recursive color regions, and dissect image layers based on associated rules (block 4).

3. Generate an initial encapsulated tree for the current pathway and prepare visual object variations to be searched (block 6).

Average all data in initial encapsulated tree for the current pathway and determine the existence state of visual objects from sequential frames (block 8).

4. Execute two search functions to look for best pathway matches (block 14).

The first search function uses search points to match a visual object to a memory object. Uses breadth-first search because it searches for visual objects in the initial encapsulated tree from the top-down and searches for all child visual objects before moving on to the next level.

The second search function uses guess points to match a memory object to a visual object. It uses depth-first search to find matches. From a visual object match in memory the search function will travel on the strongest-closest memory encapsulated connections to find possible memory objects. These memory objects will be used to match with possible visual objects in the initial encapsulated tree. This search function works backwards from the first search function.

The first search function will output general search areas for the second search function to search in. If the second search function deviates too far from the general search areas, the second search function will stop, backtrack and wait for more general search areas from the first search function.

5. Generate encapsulated trees for each new object created during runtime.

If visual object/s create hidden object then generate encapsulated tree for said hidden object. Allocate search points in memory closest to the visual objects that created the hidden object (block 22).

If visual object/s activates a learned object (or activated element object) then generate encapsulated tree for said learned object. Search in memory closest to the visual object/s that activated the learned object (block 24).

If pathways in memory contain patterns determine the desirability of pathway (block 12).

6. If matches are successful or within a success threshold, modify initial encapsulated tree by increasing the powerpoints and priority percent of visual object/s involved in successful search (block 10).

If matches are not found or difficult to find, try a new alternative visual object search and modify initial encapsulated tree by decreasing the powerpoints and priority percent of visual object/s involved in unsuccessful search. If alternative visual object search is a better match than the original visual object match modify initial encapsulated tree by deleting the original visual object and replacing it with said alternative visual object (block 16).

7. Objects recognized by the Al program are called target objects and element objects are objects in memory that have strong association to the target object. The AI program will collect all element objects from all target objects and determine which element objects to activate. All element objects will compete with one another to be activated and the strongest element object/s will be activated. These activated element objects will be in the form of words, sentences, images, or instructions to guide the AI program to do one of the following: provide meaning to language, solve problems, plan tasks, solve interruption of tasks, predict the future, think, or analyze a situation. The activated element object/s is also known as the robot's conscious (block 18 and pointer 40).

8. Rank all best pathway matches in memory and determine their best future pathways. A decreasing factorial is multiplied to each frame closest to the current state (block 26 and block 28).

9. Based on best pathway matches and best future pathways calculate an optimal pathway (block 34).

If the optimal pathway contains a pattern object, copy said pattern object to the current pathway and generate said pattern object's encapsulated tree (block 30).

10. Store the current pathway and the initial encapsulated tree (which contains 4 data types) in the optimal pathway (block 32).

Rank all objects and all of their encapsulated trees from the current pathway based on priority and locate their respective masternode to change and modify multiple copies of each object in memory (block 36).

11. Follow the future pathway of the optimal pathway (block 38).

12. Universalize data and find patterns in and around the optimal pathway. Bring data closer to one another and form object floaters. Find and compare similar pathways for any patterns. Group similar pathways together if patterns are found (block 44).

13. Repeat for-loop from the beginning (pointer 42)

Image layers

The purpose of the storage area is to store large amounts of images and movie sequences so that data is organized in an encapsulated format to compress data and prevent unnecessary storing of repeated data. Images should be grouped together in memory based on: closest neighbor pixels, closest neighbor images, closest timing of images, closest strongest strength of images and closest training of images. Movie sequences should be grouped together in memory based on: closest next (or before) frame sequences, closest timing of frame sequences, closest training of frame sequences and closest strength of frame sequences.

A combination of criterias to store images and movie sequences listed above are used for storing data in memory. These criterias establish the rules to break up and group data in images and movie sequences. When an image is sensed by the AI program there are no information to establish what is on that image. There are no rules as well to break up the images into pieces. Certainly, the computer can't just randomly break up the input data and randomly group the pieces together—all objects should have set and defined boundaries. The present invention provide a “heuristic way” to store images/movie sequences (data), break up data into the best possible encapsulated groups, and universalize data in memory.

The AI program receives input visually in terms of 2-dimensional movie sequences. The AI program will use hidden data from moving and non-moving objects in the movie sequences to create a 3-d representation of the 2-d movie sequences; and store the 2-d movie sequences in such a way that a 3-d environment is created.

With this said, there exist a third set of rules to group data in memory. 3-d movie sequences should be grouped together in memory based on: closest 3-d neighbor of pixels, closest 3-d neighbor of images, closest 3-d strength of images, closest 3-d training of images, closest 3-d timing of images, closest 3-d next (or before) frame sequences, closest 3-d timing of frame sequences, and closest 3-d strength of frame sequences.

Storing 2-dimensional movie sequences in a 3-dimensional network

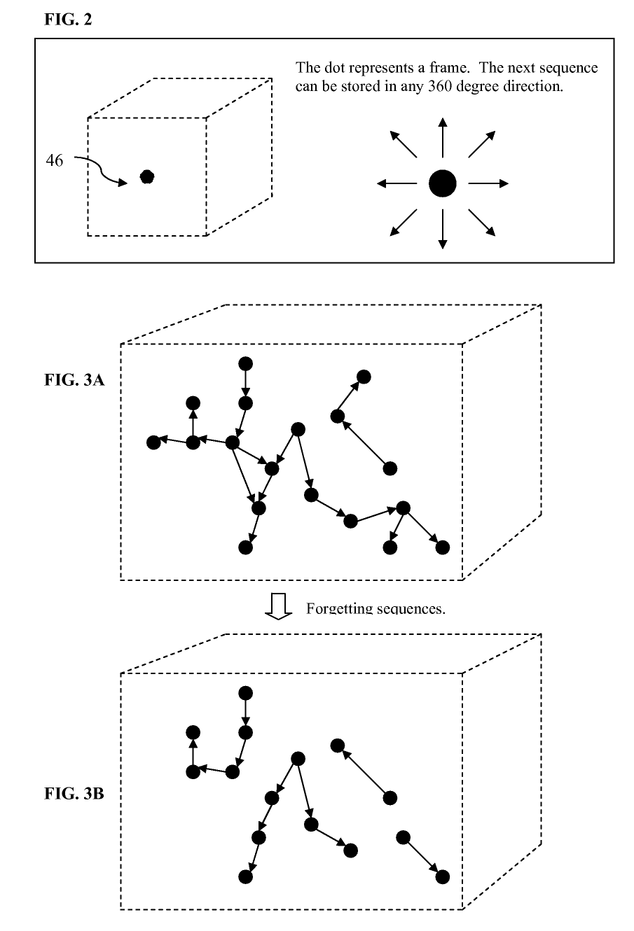

The storage area is made up of a 3-dimensional grid. Each space in the 3-d grid contains a 360 degree view. This means that each point inside the network can store the next sequence in the movie from 360 degrees. To better understand how this works, the diagram in FIG. 2 shows a 3-d grid with dot 46 in the middle. Dot 46 represents one frame in the network; and the next frame can be stored in any 360 degree direction.

This is important because life in our environment is 360 degrees at any given space. A person can stand in one place and look at the environment from the top, bottom, left, right and all the directions in between. The brain of this robot must have the means of storing every frame sequence.

The human brain stores information not in an exact manner, but in an approximate manner. The movie sequences that are trained often will be stored in memory while the movie sequences that are not trained often will not be stored in memory. For an object like a house, if a human being has seen the house from the front and side, but not from the back, then his/her memory will only have movie sequences of the house from the front and side. In fact, when data begins to forget only sections of the house from the front and side are stored in memory. This happens because data in frames forget information. FIGS. 3A-3B shows how movie pathways are forgotten.

Fabricating 3-d data from 2-d images

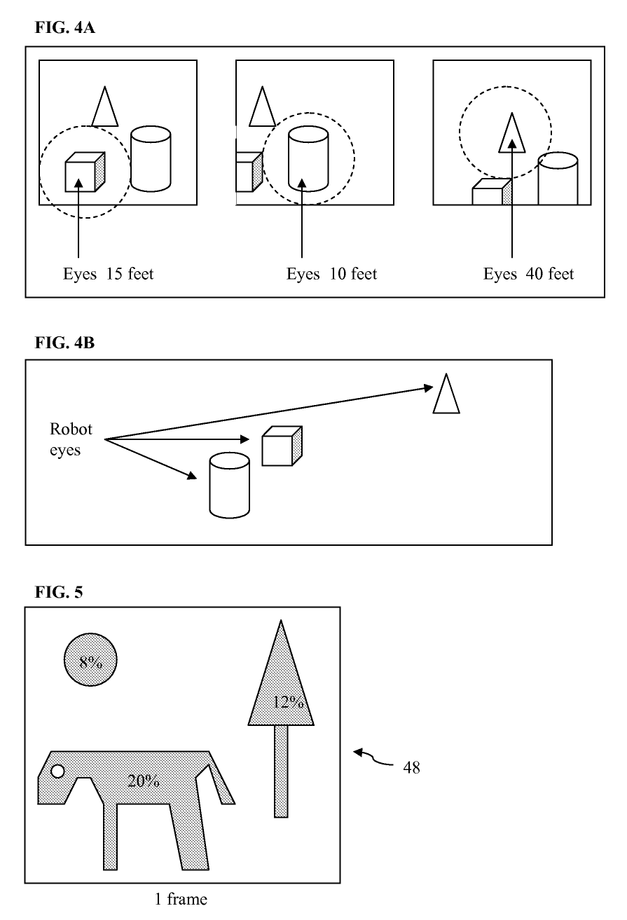

The movie sequences that are sensed by the robot are actually 2-dimensional. In order to make the robot understand the movie sequence is actually 3-dimensional we have to use focus and eye distance. Referring to FIG. 4A, human eyes are different from frames in a movie because the human eye can focus on an object while a frame from a movie has equal visibility. The focus area is clear while the peripheral vision is blurry. As the eyes focus on a close object the retinal widens, and when the eyes focus on far objects the retinal shortens. The degree in which the eye widens or shortens determine the distance between the object seen and the robot's eyes. This will give the 2-d images in movie sequences dept; and provide it with enough information to interpret the data as 3-dimensional.

Based on the focus factor the robot will create 3-d data from 2-d images. This means that if there exist two images that are exactly the same in terms of pixels, it doesn't mean that they are the same 3-dimensionally. One image can be a picture of a house and the other image can be a real-life view of a house. Both are exactly the same, but the real life-view contains dept and distance. The robot will store these two images in the same group, but the distance data will be different.

Referring to FIGS. 4A-4B, the distances of the images are also important. The triangle is far away, but the cube and the cylinder is close by. If we train the example in FIG. 4A with equal frequency, then the cylinder will have higher powerpoints than the triangle because of the distance. The size of the object is also a factor in how strong (powerpoints) each object will be. The cylinder takes up more pixels than the triangle, therefore the cylinder will have more powerpoints.

The focus and eye distance is supposed to create a 3-d grid around the 2-d images. This creates dept on the 2-d images and this information will be used to break up the pixels into probable pieces. Each pixel in the frame will try to connect to each pixel in the next sequence. This is called “the existence of pixels” where the computer tries to find what objects in the movie sequences are: existing, non-existing, or changed. For example, if a human face is staring at the robot and the next frame is the human face turning to the right, the robot needs to know that the shape of different encapsulated objects has changed. It has to lock onto the morphing image of the nose, eyes, mouth, cheek bones, forehead, hair, ears, neck and so forth. Sometimes pixels in images disappear or new pixels that wasn't there before appear.

In order to recognize all these changing things the AI program has to group images together based on a variety of rules. Repetition is the key; the more the sequence is encountered the more the robot will learn the sequence. Another way of learning the existence of an object is through the human conscious where the robot learns language and activates sentences that will tell the robot what is happening in the movie sequence. All these rules will be explained further in later sections.

Image layers and movie sequences

Some terminology must be established first before explaining the functions of the image processor. Objects are the items we are searching for in memory. This one object is made up of sub-objects and these sub-objects are made up of other sub-objects. One example is a movie sequence: Pixels are encapsulated in images, images are encapsulated in frames, frames are encapsulated in movie sequences and movie sequences are encapsulated in other movie sequences.

Image layers are the combination of pixels. Each image layer comprises one or more pixels. Pixels on the image layer do not have to be connected; they can be scattered or connected (Most likely pixels will be connected because the image processor group connected pixels more than scattered pixels). Sequential image layers are image layers that span in sequential frames. They can have a number of image layers in each frame. Some of these image layers can be connected or scattered (depending on the training and the robot's conscious). These image layers from frame to frame can also be existing, non-existing, or changed.

Image processor

The image processor is designed to break up the current pathway into pieces (called partial data) so that the strongest image layers or movie sequences are dissected and grouped together. The output of the image processor is to generate an initial encapsulated tree for the current pathway. (For simplicity purposes, this invention will cover images and movie sequences only; all nodes in the encapsulated tree for the current pathway are called visual objects).

The initial encapsulated tree will provide the AI program with a heuristic way to search for unknown data from images and movie sequences. When the AI program receives input from the environment, it has no idea what is contained in the input—there are no predefined information or relationships between individual pixels. The only way for the AI program to understand the input is by finding an identical copy in memory.

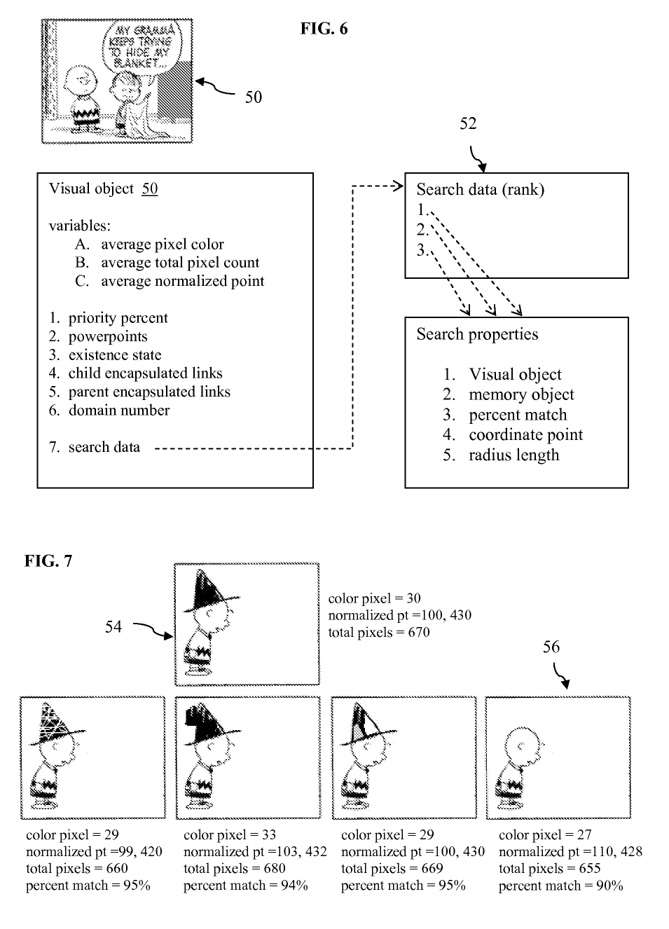

Each node in the initial encapsulated tree is called a visual object. The top node is called a visual object, the middle-level nodes are called visual objects and the bottom-level nodes are called visual objects. FIG. 6 illustrates a visual object 50 and all information attached to it. Each visual object comprises: a frame sequence with at least one frame, three variables: (A) average pixel color (B) average total pixel count (C) average normalized point; a priority percent; a powerpoint; an existence state, encapsulated connections with other visual objects; a domain number, and search data 52.

Visual objects can be pixels, image layers, frames or frame sequences. Each frame will have its own sub-encapsulated tree. If frame sequences contain 10 frames then an encapsulated tree will be generated for each frame. The initial encapsulated tree in this case will contain all 10 encapsulated trees for all 10 frames.

Each visual object will have a priority percent. The priority percent is the importance of that visual object in a given domain. Each visual object will have a priority percent to indicate to the search function how important this visual object is. This will give the search function a better idea of what should be searched first, where should the search be done, and what possible search areas to search in. When all priority percent from all visual objects are added up, within a given domain, it will equal 100%. The current pathway is the domain for all visual objects in the initial encapsulated tree.

FIG. 5 shows the priority percent of visual objects in one frame. If the domain is 1 frame 48 then all images that make up that 1 frame 48 will equal 100%. In this example the image processor found the horse to be 20%, the tree 12%, the sun 8%, and the rest of the image layers make up 60%. If the tree and the horse are grouped together in a visual object then that visual object's priority percent is 32%.

Comparing visual objects

When comparing visual objects, the three variables (or comparing variables) establish the overall data to compare. The closer two visual objects are in terms of all three variables the better the match. FIG. 7 shows visual object 54 is compared to 4 similar visual objects in memory. Visual object 54 is 90% similar to visual object 56.

The image processor will use certain dissection functions to cut out prominent image layers from images and movie sequences. There are basically 4 dissection functions: dissect image layers that are moving, dissect image layers that are partially moving, dissect image layers by calculating the 3-dimensional shape of all image layers in the movie sequence, dissect image layers by calculating dominant color regions using recursion, and dissect image layers using associated rules.

The two functions that really work for still pictures is “dissecting image layers by calculating dominant color regions using recursion” and “dissecting image layers using associated rules”. Since still pictures have no pre-existing information these two functions provide a heuristic way of breaking up image layers and grouping them together.

The first three functions work well with movie sequences. In the case of “dissecting image layers that are partially moving”, the image processor will try to combine this dissection function with the last two dissection functions to cut out the remaining probable image layers.

Dissect image layers that are moving

This dissection function is very simple to understand. If one image layer is moving in the environment and the total image layer is found, then cut out that image layer. This means that the cut is very clean and the entire image layer is cut out from beginning to end. It's kind of like cutting out one image from one picture, if the image can be taken out of the picture that means it's a clean cut.

Dissect image layers that are partially moving

If the cut is not clean and the image is still attached to the picture then that image is partially cut. This is what happens when some visual objects move while other visual objects stay still. One example is a human being. Someone can stand still in front of a camera and wave his arm back and forth. The arm is moving, but the human being is standing still. The image processor will not know that the arm is part of the human being.

Dissect image layers by calculating dominant color regions using recursion

The initial encapsulated tree has the average pixel color of all visual objects. The average pixel color at the top of the initial encapsulated tree will decide how important average pixel colors are in the lower-levels. Dominant colors can be computed by following a chain of parent visual objects. This information will provide the image processor with possible color regions that are considered dominant and other color regions that are considered minor. With this technique, the image processor can cut out probable image layers from still pictures.

Dissect image layers by calculating the 3-dimensional shape of all image layers in movie sequences

By analyzing the 2-dimensional movie sequences and adding in focus and distance to the images, a 3-dimensional grid will pop up. The robot will be viewing real-life images from the environment. This grid will guide the breaking up of data in memory because it will tell the image processor where the edges of any given objects are. Focus and distance is used to show dept in a still image. Close objects will be cut out compared to far objects. For example, if there exist one frame with a still hand in front and a still human being in the background, the image processor will understand that the hand is one object that is closer to the robot than the human being. The hand is focused on so it is clear, while the human being is farther away and is fuzzy. This prompts the AI program to cut out the hand and designate that as one visual object.

Dissecting image layers using the associated rules

Grouping image layers should be based on: closest neighbor pixels, closest neighbor images, closest timing of images, closest strongest strength of images and closest training of images. Grouping movie sequences should be based on: closest next (or before) frame sequences, closest timing of frame sequences, closest training of frame sequences and closest strength of frame sequences.

A combination of criterias to store images and movie sequences above are used for storing data in memory. These criterias establish the rules to break up and group data in images and movie sequences. When an image is sensed by the AI program there are no information to establish what is on that image. There are no rules as well to break up the images into pieces. Certainly, the computer can't just randomly break up the input data and randomly group the pieces together—all objects should have defined and set boundaries. The associated rules provide a “heuristic way” to break up frame sequences into the best possible encapsulated visual objects.

The AI program receives input visually in terms of 2-dimensional movie sequences. The AI program will use hidden data from moving and non-moving objects in the movie sequences to create a 3-d representation of the 2-d movie sequences; and store the 2-d movie sequences in such a way that a 3-d environment is created.

With this said, there exist a third set of associated rules for grouping 3-d images and 3-d movie sequences. 3-d movie sequences should be grouped together based on: closest 3-d neighbor of pixels, closest 3-d neighbor of images, closest 3-d strength of images, closest 3-d training of images, closest 3-d timing of images, closest 3-d next (or before) frame sequences, closest 3-d timing of frame sequences, and closest 3-d strength of frame sequences.

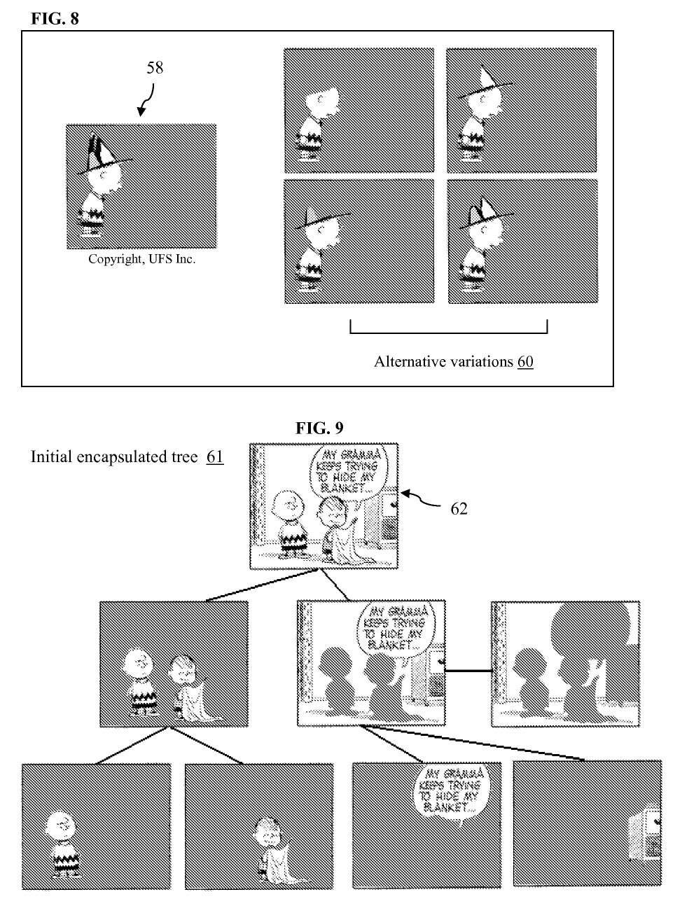

The image processor will cut out most of the image layers on the frames and also cut out most of the encapsulated visual objects in each image layer. It will also find alternative variations of visual objects to use to search for matches in memory. FIG. 8 shows visual object 58 and the different variations 60 of the same object (The grey areas are empty pixels).

When the AI program generates the encapsulated tree for the visual object, it is important that the AI program generates the same or similar encapsulated tree for the same visual object. Infact, when a similar image is encountered the AI will generate a similar encapsulated tree for that image. If imageA is encountered once the AI program generates encapsulated tree 1A. If imageA is encountered a second time the AI program will generate encapsulated tree 1A or something very similar. If imageB is an image that is similar to imageA and the AI program generates 1B, then 1B should be similar to encapsulated tree 1A. This is important because if the encapsulated tree is different for similar images it takes longer to find a match.

The image processor should be a fixed mathematical equation where it generates the same or very similar results for the same visual object. Similar visual objects will generate similar encapsulated trees.

The priority percent for each encapsulated object is determined by the 5 dissection functions. The priority percent of image layers is determined by the 5 dissection functions in this order:
(1). dissect image layers that are moving
(2). dissect image layers that are partially moving
(3). dissect image layers by calculating the 3-dimensional shape of all image layers in movie sequences.
(4). dissect image layers by calculating dominant color regions using recursion
(5). dissecting image layers using associated rules

Image layers that are cut out with the higher-level functions will have a higher priority percent. For example, if an image of Charlie brown is cut out (clean cut), it has more priority than a partially cut image.

An image layer that is cut out with both function 2 and function 3 will have higher priority than an image layer that is cut out from function 3 and function 4. Tweaking of the importance of each function and the combination of functions is up to the programmer.

The reason that a clean cut is a good image layer search is because that image layer has been delineated perfectly and all the edges of the object are cut out. The reason the fourth function is last is because the image processor isn't sure what the edges of the image layers are. Given that a 2-d image is provided, the AI program has to rule out using expert probable systems to cut out image layers. The third function will have a better idea of the edges from a still picture because the edges can be calculated based on the closest objects. Off course, the third function can only work with real-life views of the environment. It will not work for truly 2-d images.

When the AI program isn't sure what the edges of the image layers are it has to fabricate alternative image layer combinations. It will rank them and test out which image layers are better than others by matching them with image layers in memory. When the search function finds out it has made an error in terms of delineating certain still image layers, it will change the image layer's encapsulated visual objects by modifying branches of the initial encapsulated tree and changing the priority percent of visual objects that are involved in the error search (from here on image layers will be referred to as visual objects)

FIG. 9 shows the initial encapsulated tree 61 for current pathway 62. We have learned that the current pathway 62 (emphasis on visual objects) use the image processor to generate the initial encapsulated tree 61. The initial encapsulated tree 61 contains the hierarchical structure of visual objects and broken up into strongest encapsulated visual objects. Each visual object in the encapsulated tree is given a priority percent. The priority percent determines their strength in the initial encapsulated tree 61 for the current pathway 62. (The grey areas are empty pixels).

The very strong visual objects (or image layers) are at the top levels while the weak visual objects are stationed at the bottom. If I were to show encapsulated tree 61 at the lower tree levels, the unimportant visual objects will be there. The “noise” of the current pathway will be filtered out to the lower levels. When the search function searches for information it will search for important visual objects first before moving on to the less important visual objects.

The purpose of the lower levels in the initial encapsulated tree is not to search for data in memory, but to break up the current pathway into its smallest elemental parts (groups of pixels or individual pixels) so that when the initial encapsulated tree gets stored in memory, self-organization will knit similar groups together. Thus, bringing association between two or more pathways (or visual objects).

The next step is to average out all visual objects in the initial encapsulated tree for the current pathway.

Averaging data in the initial encapsulated tree

After the initial encapsulated tree is created for the current pathway, all visual objects from the initial encapsulated tree will be averaged out. Each visual object in the initial encapsulated tree will average the value of each of its variables based on its' child visual objects. For example, if a parent visual object has 3 child visual objects then the parent visual object will add up all the values for one variable and divide by 3. If a parent visual object has 10 child visual objects then the parent visual object will add up all the values for one variable and divide by 10. All visual objects in the initial encapsulated tree will have the average value for each of its variables.

Each variable in a visual object will also have an importance percent. The importance percent is defined by the programmer to describe how important that variable is to the visual object. Each variable will have an importance percent. If you add up all the importance percent for all variables it will add up to 100%.

There is one more factor added to the equation. The priority percent of a child visual object should influence the average value of one variable. The higher the priority percent the more that child visual object should influence the average value of one variable. A factorial (0.2) is also multiplied to indicate that the priority percent of a child visual object should not matter that much in the average value. 0.2 is used because the worth of the visual object shouldn't over power the average value of a given variable for all child visual objects.

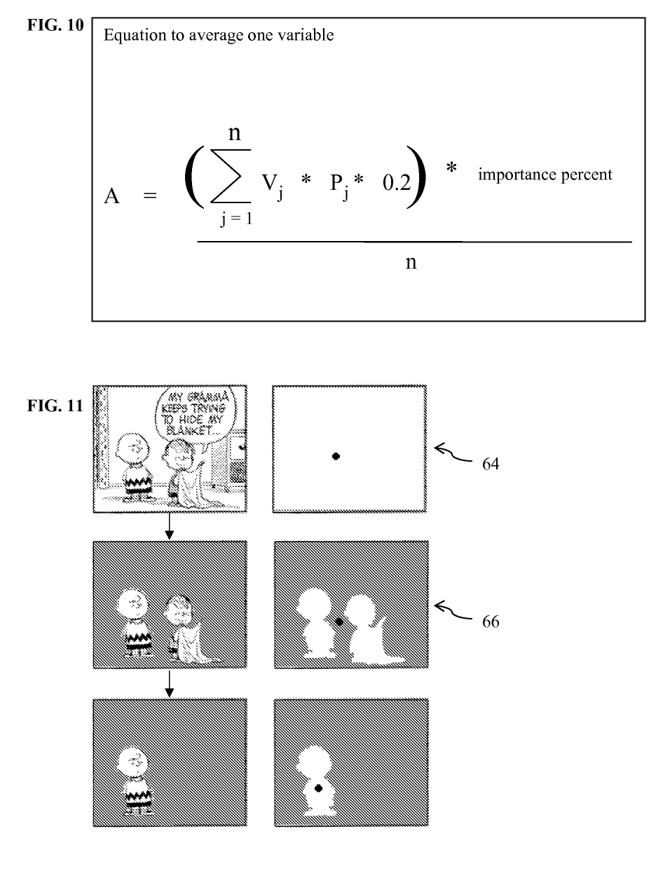

The equation to calculate the average value for one variable in one visual object is presented in FIG. 10. V represents one variable, A represents the average value of V, n represents the number of child visual objects, P represents the priority percent of a child visual object, the importance percent is for variable V.

I use this technique because when the AI program searches for possible matches it won't search every single pixel in a visual object. The visual object should contain the average value of a variable from all of its encapsulated visual objects. So, when the AI program searches for matches, it only needs to compare three variables: average normalized point, average total pixels, and average pixel color. These three variables sum up the visual object compactly so that the search function doesn't have to match every pixel in an image or rotate or scale the image to find a match or convolute the image to find a match.

FIG. 11 shows how the average value is computed for the normalized point. The grey areas indicate empty pixels. Visual object 64 has a normalized point close to the center of the frame. The normalized point should be in the center only if all image layers are equal in priority. The fact that some image layers are more important than others influence the average normalized point. In this case, Charlie brown and the character with the blanket have more priority, so their normalized points matter more. In the case when there are two separate image layers, such as in visual object 66, the normalized point will fall in the center of both image layers.

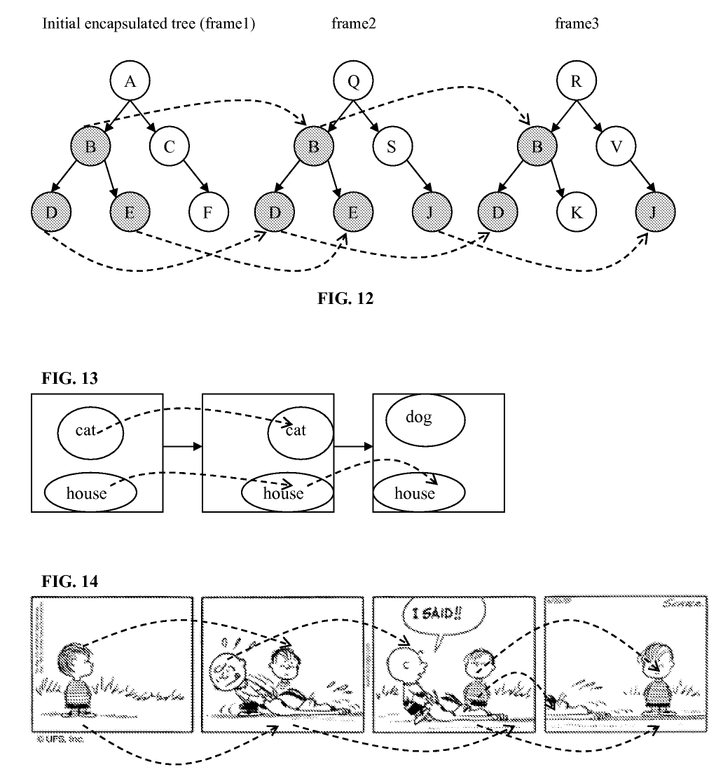

In addition to averaging data, the AI program has to determine the existence state of each visual object in the initial encapsulated tree. All visual objects have to be identified from one frame to the next according to one of three values: existing, non-existing or changed. For each frame all pixels, all image layers, and all combinations of image layers have to be identified from one frame to the next. In FIG. 12, the initial encapsulated tree records what visual objects are existing for three frames. Notice that visual object B exists for all three frames. Visual object E only exist in frame 1 and frame 2, but not in frame 3. Visual object J only exists from frame 2 to frame 3, but not in frame 1.

FIG. 13 shows the existence of learned objects. Learned object “cat” only exist in frame 1 and frame 2. Learned object “house” exist in all three frames. Learned object “dog” only exist in frame 3. The special thing about learned objects is that the image layers from frame to frame can look totally different, but the AI program will still classify it as the same learned object. For example, the learned object “cat” can be any cat image in the cat floater. The cat image can be an image of a cat from the front or back or side, the learned object “cat” will identify them as the same image layers.

FIG. 14 shows a cartoon illustration of visual object and their existence state. Every pixel in the cartoon from one frame to the next must be identified. The AI program will try to lock on and determine what pixels, image layers or combination of image layers exist from one frame to the next.

Quick generation of encapsulated trees for sequential frames

If images aren't very different from one frame to the next, the image processor can use the old encapsulated tree from the previous frame to generate parts of the encapsulated tree in the next frame. This happens when visual objects don't move and most of the images are exactly like the previous frame. If the existence of encapsulated objects are the same or similar in the next frame, then generate the encapsulated tree for the next frame similar to the previous frame. Parts of the encapsulated trees will look the same while other parts will look different. This saves processing time and stops any unnecessary repeated computer calculations.

Forgetting information in image layers and movie sequences

The initial encapsulated tree for the current pathway will forget information by deleting visual objects starting on the lowest level and traveling up the tree levels. The strongest visual objects will be forgotten last and the weak visual objects will be forgotten first. Specifically for images and movie sequences, the average pixel color will represent the overall value of a visual object. If all child visual objects are forgotten, the pixel cells they occupy will be represented by the average pixel color from its parent visual object. Initially, the movie sequence will have sharp resolution, but as the movie sequences forget information the images are pixelized. Important image layers will be sharp and the minor image layers will be pixelized or gone. Movie pathways will also break apart into a plurality of sub-movie sequences.

Search function

The initial encapsulated tree for the current pathway is what the search function wants to find in memory. Each element in the initial encapsulated tree is called a visual object. The data we want to compare are called memory encapsulated trees (or pathways). Each element in the memory encapsulated tree is called a memory object.

The more visual objects matched in the initial encapsulated tree the better the pathway match. The more accurate each visual object match is the better the pathway match.

The search functions can only travel on memory encapsulated connections that belong to the same pathway (or memory encapsulated tree). In later sections, this problem is solved when I explain about universalizing pathways. For example, if a search point was traveling on memory encapsulated connections for pathwayl then it can't travel on memory encapsulated connections for pathway2.

The search function will execute two functions to look for pathways in memory: first search function and second search function. Both functions will work together to find the best pathway matches.

The first search function uses “search points” to match a visual object to a memory object. It uses breadth-first search because it searches for visual objects in the initial encapsulated tree from the top-down and searches for all child visual object before moving on to the next level.

The second search function uses “guess points” to match a memory object to a visual object. This search method uses depth-first search to find matches. From a memory object match in memory the search function will travel on the strongest-closest memory encapsulated connections to find possible memory objects. These memory objects will be used to match with possible visual objects in the initial encapsulated tree. This search function works backwards from the first search function.

Search points

Each search point has a visual object to search, a memory object to match, percentage of match between visual object and memory object, a radius length to search and a location for the best match so far.

Each search point have radius points, said radius points are equally spaced out points that can have 1 or more copies of itself to triangulate an average location a visual object might be located in memory.

Each radius point will lock onto a different memory object and compare said visual object to a memory object and output a match. All radius points will process the data and triangulate an optimal memory object to be matched with said visual object.

Each search point goes through recursion: If search_point(visual object) has a successful match (memory object) then execute two recursions:
(1). search_point(visual object)
(2). guess_point(memory object)
else if search_point(visual object) has an unsuccessful match (null) then execute one recursion:
(1). search_point(visual object)

Each search point has a recursion timer. The recursion timer will indicate how long to execute the next recursive thread. If the recursion timer is low that means it takes longer for the recursive thread to execute (thus, less search points devoted to search for that visual object). If the recursion timer is high that means it will be faster for the recursive thread to execute. (thus, more search points devoted to search for that visual object).

The criteria for the recursion timer are: if the search point finds better matches increase the recursion timer and decrease the radius length. If the search point finds worst matches slow down the recursion timer and increase the radius length to search for the same visual object in the next recursive thread.

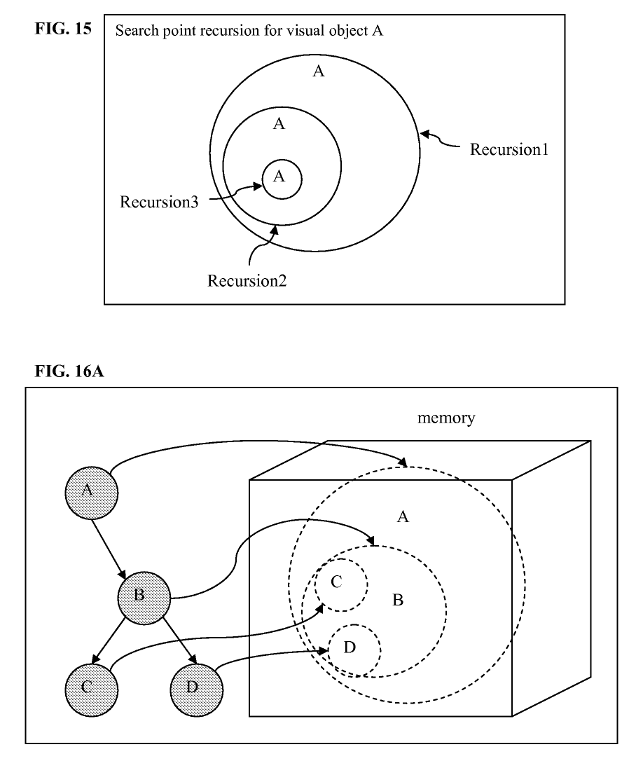

Each search point will go through recursion to find better and better matches. The first recursion will pinpoint a general area. The second recursion will pinpoint a more narrow area. The third recursion will pinpoint an even narrower search area. This will go on and on until the search point finds an exact match or there are no better matches left to find. FIG. 15 is a diagram of the narrowing of search areas after every recursive iteration. If better matches are found, visual object “A” will change its search area. Child visual objects that depend on visual object “A” will have there search area changed as well.

Guess points

From a memory object match in memory the search function will travel on the strongest-closest memory encapsulated connections to find possible memory objects. These memory objects will be used to match with possible visual objects in the initial encapsulated tree. The search function will also combine visual objects and match them to possible memory objects. This search function works backwards from the first search function.

There are 2 criteria to determine what memory object to designate for a search: 1. the stronger the memory encapsulated connections leading to the memory object are the better chance it will be picked. 2. the stronger the powerpoints of the memory object is the better chance it will be picked

As soon as the memory object is picked the function will compare it to the visual objects in the initial encapsulated tree. It's easy to find a match in the initial encapsulated tree because it doesn't have too much data to compare. Visual objects can also be combined and matched. The strongest match will be outputted.

Each guess point goes through recursion: If guess_point(memory object) has a successful match (visual object) then execute two recursions:
(1). guess_point(memory object)
(2). search_point(visual object)
else if guess_point(memory object) has an unsuccessful match (null) then execute one recursion:
(1). guess_point(memory object)

In the search point there is a last step that wasn't mentioned (for simplicity purposes). The last step is: when the search point finds a match it will locate the match's masternode. If there are multiple copies of one visual object in memory the masternode is the strongest copy of the visual object and the masternode has reference points to all copies in memory. If multiple copies of the same visual object are in the same general area the search function will use this data for future searches.

The search function designates search points or guess points to said first search function and said second search function, each search point or guess point will find matches in memory. If matches are successful or within a success threshold, modify initial encapsulated tree by increasing the powerpoints and priority percent of visual object/s involved in successful search. If matches are not successful or within an unsuccessful threshold, try a new alternative visual object search and modify initial encapsulated tree by decreasing the powerpoints and priority percent of visual object/s involved in unsuccessful search. If alternative visual object search is a better match than the original visual object match modify initial encapsulated tree by deleting the original visual object and replacing it with said alternative visual object.

Search point example

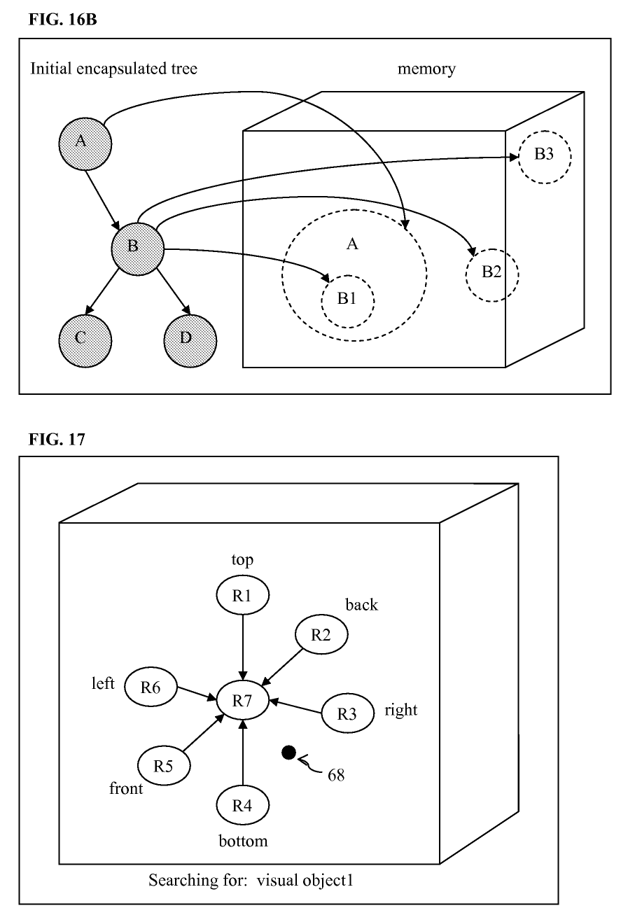

The parent visual objects provide a general search area for its child visual objects. In FIG. 16A, visual object “A” has a big search area. Visual object “B” is contained in visual object “A”s search area. Visual object “C” is contained in visual object “B”s search area. These hierarchical search areas provide boundaries for the search function to limit the search area.

The search area radius is calculated by the accuracy of the match. If the percent match is 50% then the radius will be wide. If the percent match is 80% then the radius will be narrower. If the percent match is 100% then the radius is very narrow (depending on how much data is in memory. In some cases that is a 100 percent match). Another factor of the search area is the tree-level the visual object is located. If the visual object is the top visual object then the radius is wider. If the visual object is at the middle tree-levels then the radius is narrower.

The AI program will collect information on most search points and use that to determine where to allocate search points to maximize the search results. If some search areas are not finding enough matches the AI program will devote search points in other search areas. If some search areas are finding lots of matches the AI program will devote more search points in that area.

Multiple copies of a visual object

If there are multiple copies of a visual object, the search function will limit the search to only the copies that are contained in the parent's search area. In FIG. 16B, visual object B has 3 copies in memory (visual object B1, B2, B3). The search function will exclude B2 and B3 because they are not within the boundaries of visual object “A”s search area.

FIG. 17 is an illustration of a search point. The search point is given a visual object to compare called visual object1. R1, R2, R3, R4, R5, R6, and R7 are radius points and they are equally spaced out. In FIG. 17 the radius points are structured in a top, bottom, front, back, left, right and center manner. Each radius point will lock onto a dominant memory object in their area and compare with visual objectl. When all matches are made, the AI program will triangulate a probable area to find the optimal memory object. The optimal memory object is identified by pointer 68. Visual objectl will be compared to the optimal memory object and output a percent match. The percent match will be assigned to the search point.

The radius points can be in any configuration. It can be configured in a ring shape, triangle shape, sphere shape, or arbitrary shape. The number of radius points can be 1 or more, but an adequate amount is 7 to cover a search area in 360 degrees.

Guest point example

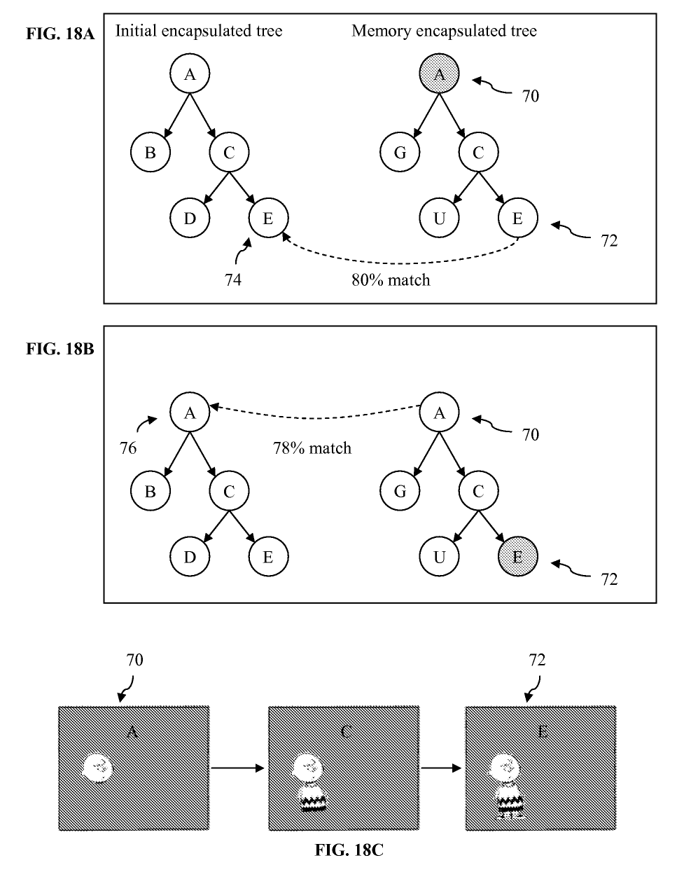

In FIG. 18A, memory object 70 has been matched. From memory object 70 the guest point will travel on the strongest memory encapsulated connection to find strong memory objects to search for. In this case, memory object 72 has been picked. The guest point will try to match memory object 72 to a visual object in the initial encapsulated tree. After the matches, visual object 74 was the best match and the match percent is 80%. (This type of searching is the direct opposite of how the search points find matches).

Let's look at another example of guess points. In FIG. 18B memory object 72 has been matched. Memory object 72 will then travel on the strongest memory encapsulated connections to find other close-by strong memory objects to search for. In this case memory object 70 has been picked. The guest point will then attempt to match memory object 70 to a visual object in the initial encapsulated tree. The guest point found visual object 76 to be the best match. The match percent is 78%. Let's say that the visual object 76 had a previous match of 42% that means the current guest match can replace the previous match because the match percent is higher.

FIG. 18C shows the same memory objects in FIG. 18B but in a cartoon sequence.

Combining visual objects to be searched

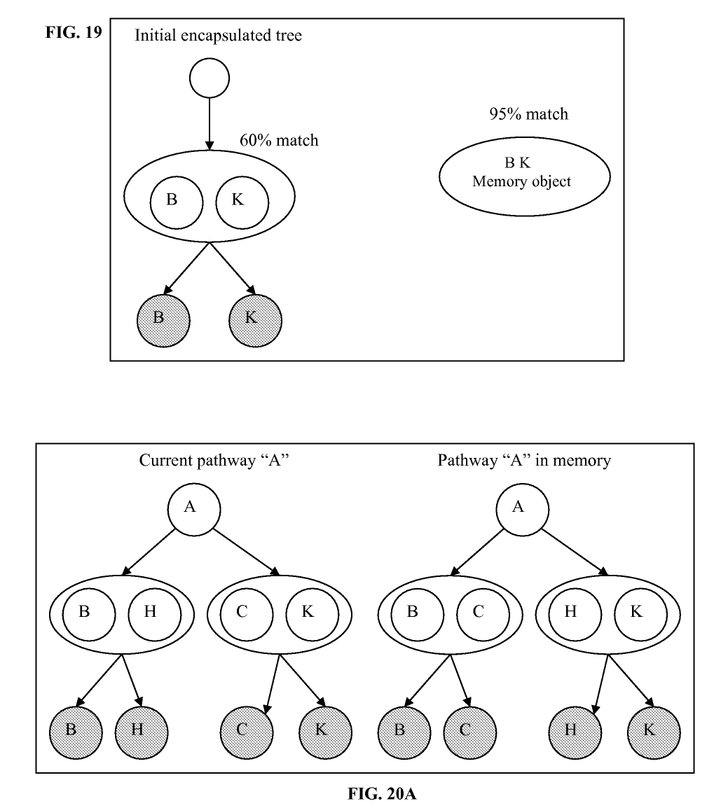

Referring to FIG. 19, if visual objects B and K are matched in the initial encapsulated tree, then the guess point can combine the two visual objects into visual object BK. If the guess point finds memory object BK as its search item then it will match to visual object BK in the initial encapsulated tree. Since the guess point match is 95% and is better than the previous match 60% it will replace the previous match.

Re-organization of the initial encapsulated tree

Re-organization of the initial encapsulated tree is required when the AI program finds out that the initial encapsulated tree created by the image processor doesn't correlate with the encapsulated trees in memory. The image processor creates an initial encapsulated tree to break up the visual object to search for data heuristically, but most of the time the initial encapsulated tree is flawed. The encapsulated tree for a pathway in memory is considered optimal. The self-organization does a good job in bringing associated groups together. With this said, the initial encapsulated tree for the current pathway should correlate with the encapsulated tree for pathways in memory.

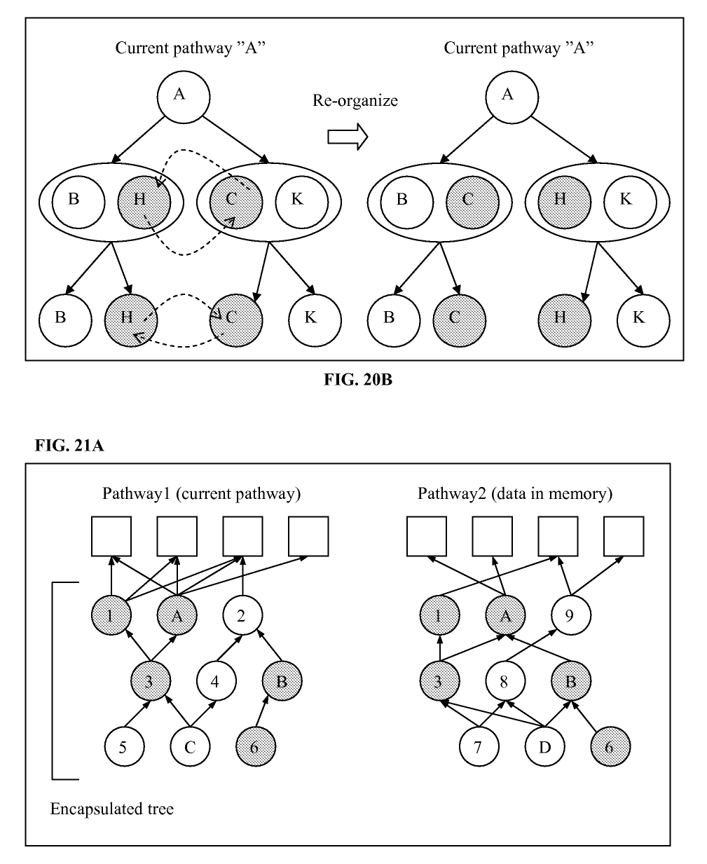

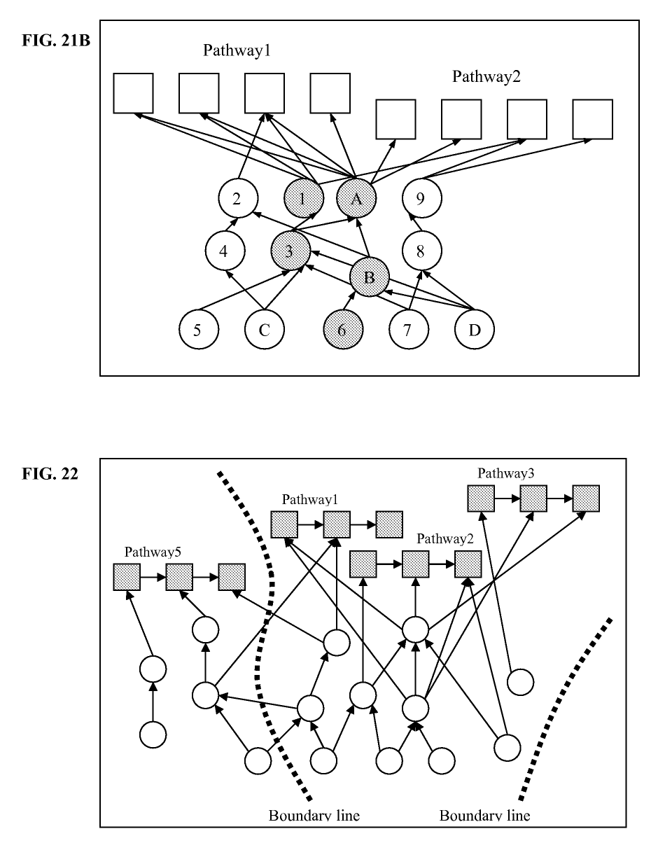

The inner workings of this function will not be disclosed in this patent because it's too long. I will demonstrate a simple example and back up the demonstration with illustrations. FIG. 20A shows the initial encapsulated tree for current pathway “A” made by the image processor. FIG. 20A shows the encapsulated tree for the same pathway “A” stored in memory. If the AI program finds visual objects B,H,C,K individually in memory, it will compare the match's parent visual objects. If the two parent visual objects don't correlate, the input current pathway “A” will go through re-organization. In this case FIG. 20B shows the flow diagram of switching visual objects “H” with visual object “C”.

One example of re-organization is when the AI program encounters a still picture of a man in a shaded and dark background. The man has black hair and the image processor thinks the hair is part of the background. When the image processor finds the image layer of the man in memory it realizes that the black hair is actually part of the man and not the background. The image processor will then cut out pixels from the background image layer and transfer these pixels into the man image layer.

The reason for re-organizing the initial encapsulated tree is because the initial encapsulated tree has to be optimal or close to optimal before it is stored in memory. If we store the initial encapsulated tree in memory as is, it won't matter as much because self-organization will knit the flawed initial encapsulated tree to one that is optimal. I think it is important that the input to be stored in memory is optimal during the time of storage and not after.

The search function will constantly be searching for data and modifying the initial encapsulated tree during the search process. By the time the search is over the initial encapsulated tree made by the image processor will be changed and all groupings will be optimal.

For the topic of universalizing pathways, visual objects won't be used anymore. Visual objects will now be referred to as simply, objects.

All 4 data types: 5 sense objects, hidden object, pattern object, and learned object are grouped together in combinations, encapsulating a series of groups. Self-organization will bring all these encapsulated groups closer and closer together. As a result, the actual pathways will be closer and closer to one another in the network based on the associated rules for images and movie sequences—group pixels closer to one another, group sequences closer to one another, group images that are more likely to be seen together, etc.

FIG. 21A is an example of two similar pathways: pathway1 and pathway2. If pathway1 (the current pathway) is stored close to pathway2, then their encapsulated groups will be grouped together and identical or similar groups will be shared. Because of the pulling effect of the encapsulated groups pathway1 and pathway2 are pulled toward each other. Their association connections with one another, gets stronger and stronger.

Both letters and numbers represent encapsulated groups from all 4 data types. The groups that are the same or similar will be grouped together. This means A, B, 1, 3, 6 are brought closer to each other and each node uses only one copy; the other copy is deleted (FIG. 21B). This prevents any repeated data from forming in the network.

Universalizing pathways

Each pathway has their encapsulated connections from all 4 data types. These encapsulated connections are only used by that pathway and no other. When searching for information the encapsulated connections can only be followed for a single pathway. This can pose a real problem when searching for large amounts of data in memory. The way to solve this problem is to universalize pathways and its encapsulated trees and create a rough idea what encapsulated connections belong to what pathways.

Referring to FIG. 22, in the diagram there are three pathways: pathway1, pathway2, and pathway3. If all three pathways are contained in a set of 10 pathways, the encapsulated groups will bring pathways closer to one another. As the encapsulated groups in all three pathways get stronger and stronger, all three pathways will break away from the 7 other pathways in the set. When this happens the 3 pathways are considered universal. That means all the encapsulated objects in all 3 pathways can be used to search for information when encountering a pathway that is either identical or similar to any of the 3 pathways.

By universalizing the pathways and its encapsulated groups each object in the hierarchical tree isn't exclusive anymore. Same objects can be found in other encapsulated groups. The universalized pathways will contain the most likely permutations and combinations of one fuzzy object. In the case of the diagram in FIG. 22, the fuzzy object is the average of pathway1, pathway2, and pathway3. This is why searching for information in the encapsulated groups is not going to be exact. The search function will be constantly changing and modifying the search results.

The reason for universalizing pathways is because the AI program will forget information. For example, if pathway1, pathway2, and pathway3 are forgotten, but part of their data still remains in memory, the AI program will not be able to get a good match on any one particular pathway. By creating a fuzzy range between the three pathways the AI is able to find a match based on the strongest encapsulated connections.

Referring to FIG. 22, pathway5 has several connections to the universal pathway and the universal pathway has several encapsulated connection to pathway5. The boundary line sets the area that excludes the universal pathway from traveling to outside pathways. It can only travel in the encapsulated connections in pathway1, pathway2, pathway3 and no other pathway.

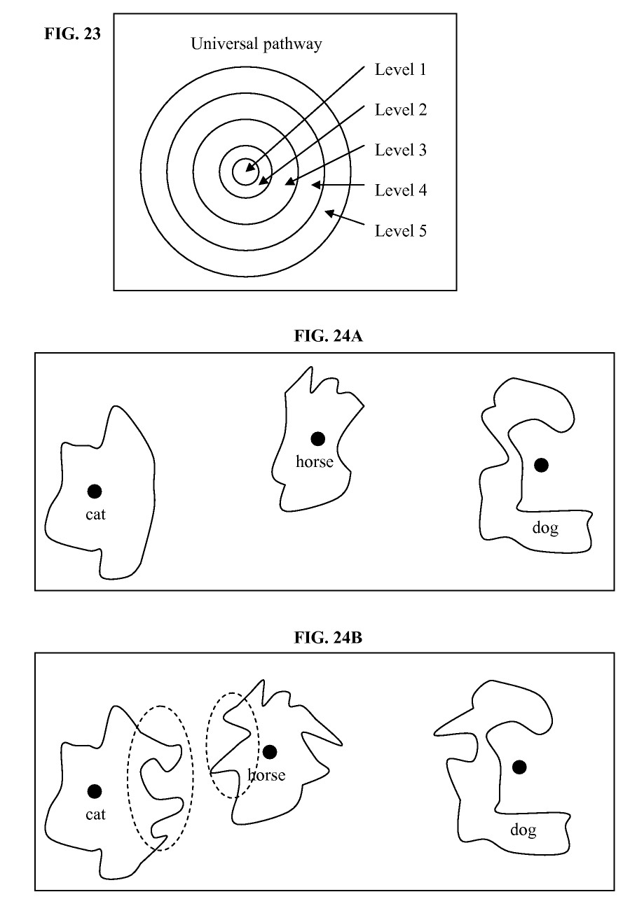

Universal pathways can have a range or degree of certainty. The diagram in FIG. 23 shows that the universal pathway has 5 levels of certainty. The closer the levels are to the center the more certain the universal pathway is. This means that the stronger the universal pathway is the more likely all the encapsulated object belongs to that one object. The search function can use this level of certainty to search for information or modify its searches by either broadening the search or narrowing the search. Broadening the search means searching in the higher levels of the universal pathway and narrowing the search means moving the search in the lower levels of the universal pathway. The search function can broaden the search first then slowly narrowing the search until a good match is found.

Referring to FIG. 23, each level will either include or exclude pathways based on how similar these pathways are. For example, levelI can contain a criteria that states any pathway that has 90 percent match will be included. In level2 the criteria can be 80 percent match, level3 can be 70 percent match, level4 can be 60 percent match, and level5 can be 50 percent match.

The structure of the universal pathways can be very complicated when there are thousands of pathways that are trying to associate themselves. But, because of the way that the network is set up the complexity is managed. Universal pathways that have too many hierarchical levels will break up into two or more groups of universal pathways. Pathways in these similar groups do not have to be exclusive.

Universalizing images and movie sequences

A simple image will have 1 center point that represents the average location of that image. If looking at the network with many similar image examples there will exist gradual points concentrated at the center—the points will look like a sphere. For movie sequences, there exist, not one, but multiple center points. Every image will have a center point, every frame will have a center point, and every movie sequence will have a center point. If looking at the network with many similar movie sequence examples the gradual points will look like a distorted 3-dimensional shape. The shape will continue to change its form and size as the robot learns more movie sequences or forget data in memory. This 3-dimensional shape is called a floater.

By using the method I talked about earlier, universal pathways, the floater will eventually break away from a set of similar floaters. In other words the floater was trained so many times that the object got stronger and stronger until it breaks away from the rest of the set. One example is animals. If the robot works at an animal shelter and takes care of animals every day, then it will contain multiple animal objects in memory. These animal objects will group themselves based on physical common traits. As the robot learns more, it will create a floater for dogs, cats, horses, pigs and cows. All the cats in the animal shelter are stored and averaged out, all the dogs in the animal shelter are stored and averaged out and so forth.

When the floater is created for a cat that means all the cats in the world are averaged out. It doesn't matter if the robot encounters different types of cats in terms of color, size, gender, weight, and length, the robot knows where to store that cat object. The center of the cat floater stores the strongest common physical traits of all cats. As the floater deviates to the higher levels the cat images are broadened.

I show in my earlier patent application that the rules program will bring association between the cat floater and a word. When the two objects (floater and word) pass the assign threshold, then the word “cat” represents the cat floater. This is how the robot learns meaning to language. For example, if the cat floater is assigned the sound “cat” that means the sound “cat” represent the cat floater. The sound “cat” is the learned group to represent any sequential cat images in the cat floater.

This technique groups data together in a different way than physical common traits. The learned objects (one of the 4 data types) group data in terms of language. We learn language and we use language to group data in memory. Language can represent not only physical objects, but events, situations, action, places, things, and complex situations. The robot will also use the learned objects to organize data in memory.

Object floaters and how they self-organize

When two or more floaters are stored in one area in memory, the AI program will average each floaters location. All sequential images from each floater will group itself together. For example, the robot is working in an animal shelter and the robot encounters three types of animal every day: cat, dog and horse. Let's use the horse as the object under investigation. If the robot encounters the horse and the cat 40 times, and the robot encounters the horse and the dog 15 times, then the robot will have stronger association between the cat and the horse. This will bring the horse floater and cat floater closer together.

Referring to FIG. 24A, the diagram shows that individual sequential images are shared between all three animal floaters. Each floater has an overall center point. As the individual movie sequences are pulled closer to one another the center point for each floater are also pulling each other closer together.

Referring to FIG. 24B, the individual sequential images of the cat are pulled closer toward the horse and the sequential images of the horse are pulled closer toward the cat. The pull will affect the center point for each floater—it will bring the overall floaters closer to one another. After averaging out the floaters, notice that the cat floater and the horse floater are closer to one another, while the dog floater is farther away. The associational strength between the cat and the horse is stronger while the associational strength between the horse and the dog are weaker. Also, notice that the dog floater has moved a little towards the horse floater.

Example of a floater

The floater object can be represented as sequential image layers of one object. If the object is Charlie brown that means the floater has all the sequential image layers of Charlie brown from all animated states including scaling and rotation. An object floater is created by training many movie sequences that contain Charlie brown. As the sequential images of Charlie brown is stored in memory the data gets stronger and stronger. It will reach a point where the sequential images of Charlie brown will break away from all the movies that contain it. The result is a Charlie brown floater.

Streaming pathways

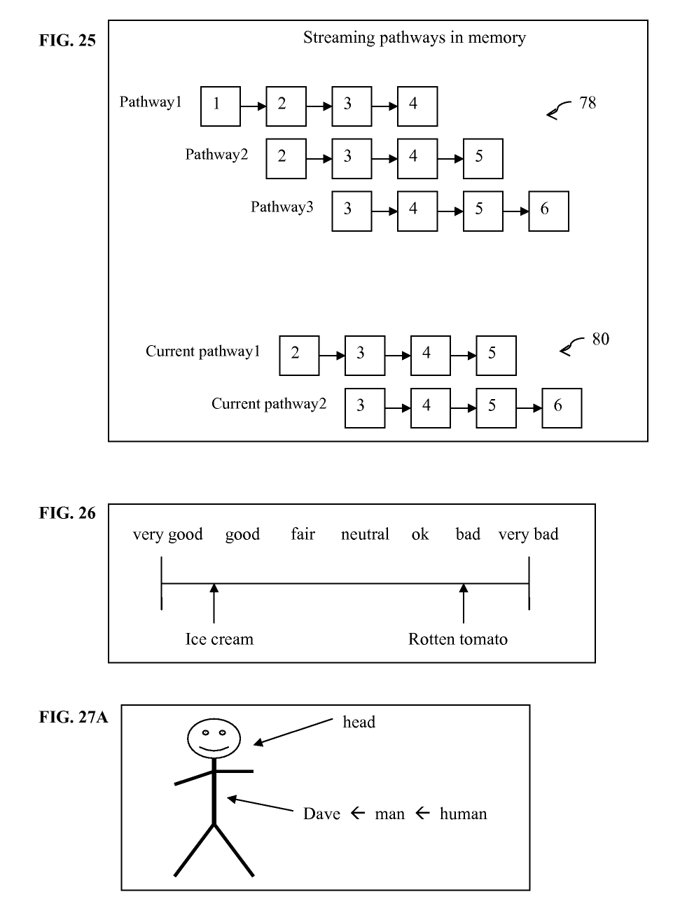

FIG. 25 illustrates streaming pathways. After each iteration of the main for-loop the AI program generates streaming pathways 80. The current pathway has a fixed amount of frames. In each iteration of the for-loop the AI program receives one extra frame from the environment and the last frame is deleted. In current pathway2, frame 2 from current pathway1 is deleted and frame 6 is added to the front of the pathway.

Pathways in memory will be very close to one another because of the similarities between sequences in frames. In FIG. 25, streaming pathways 78 shows that pathways are brought closer to one another based on there similarities. Pathway1 will be closer to pathway 2 because they have more similarities, while pathway2 and pathway3 will be closer together because of their similarities.

When the AI program is searching for streaming pathways in memory it will try to match streaming pathways that are consistent. Current pathway1 and current pathway2 is consistent with pathway2 and pathway3 in memory. In some cases streaming pathways has to be broken up into sections and stored in different parts of memory. It really depends on what the optimal pathway is in each iteration of the for-loop.

As the AI program learn more the streaming pathways get longer and longer. If it doesn't learn enough the pathways begin to break up into two or more separate pathways. The forgetting of data will eventually delete all data in the pathway if it's not retrained.

Other data types

There are many more data types that I haven't disclosed yet. In this section I will give a brief summary of other major data types. Humans have 5 different senses: sight, sound, taste, touch, and smell. So far, I have discussed visual objects in detail, but I left the rest of the senses behind. In addition to visual objects, there are sound objects, touch objects, taste objects, and smell objects. Each one of these data types is represented differently and they have their own hidden data. Just like how visual objects generate hidden data during runtime, the other data types will generate hidden data during runtime.

Sound object

Sound is 3-dimensional. There are two ears on a human being and the reason for the two ears is because of the ability to distinguish the distance of sound. Just like there are two eyes on a human being to distinguish dept and distance, two ears on a human being will distinguish distance for sound. Sound objects will be stored in a 3-dimensional network. Actually, all 5 senses are stored in the same 3-d network. They are separated in different regions in the brain.

Sound has certain characteristic that visual images don't have such as pitch, volume, distance, and tone. These characteristics will be the traits focused on when determining how sound is represented in the network. The data for sound is continuous in a pathway and it has these starting and stopping points: sound object exist, sound object non-exist, and sound object change.

Touch object

Touch is a very interesting sense because it uses patterns in order to store. Touch or feelings can be stored in sequential pathways and has basically the same characteristics as sound. Each touch sense is stored in the network based on where that touch sense is in the environment in relations to the robot's brain. For example, if you're a human being, the touch senses will actually create a 3-dimensional shape of all touch senses on your body. A 3-d shape of what the human being looks like at that current state is created in memory. For example, if someone is a child the touch objects will create a 3-d shape of that child in memory, if someone is a teen the touch objects will create a 3-d shape of that teen in memory, and if someone is an adult the touch objects will create a 3-d shape of that adult in memory.

It really depends on what the robot looks like and where the touch sensors are located. For a human being, sensors are located inside as well as outside. This means the human being has a picture of not only the external sensors, but the internal organs that have sensors as well. If the robot is a frog, then the touch sensors will create a frog shape, if the robot is a bird then the touch sensors will create a bird shape and so forth. This shape that is made by the touch data is also called the touch floater.

The shape of the robot created by the touch data is important to convey the meaning to the word “I”. That shape that is created from the touch objects is actually a floater that can be assigned to a word. The word “I” can be assigned to this touch floater and the robot will be able to identify itself not in terms of visual pictures, but by the touch floater. Actually, sound pitches can be assigned to the word “I”, the touch floater can be assigned to the word “I”, the visual floater of the robot can be assigned to the word “I”. If all these different floaters are assigned to the word “I”, then the robot will have an understanding of the word “I” (establishing identity). The visual image it sees in the mirror represent the word “I”, the sound that the robot makes will represent the word “I”, and the touch floater will represent the word “I”.

The touch objects can also be included in pattern objects to represent language. Things like “my hand touched the needle” or “the water is cold” can be understood.

Touch objects can assign pain or pleasure to other objects. The touch floater will have pain or pleasure or certain feeling recorded in the pathways. When enough experience is encountered regarding touch objects, the robot will have pain and pleasure wired into the touch floater. Any object recognized by the robot that elicit a certain pain or pleasure will have their powerpoints decreased or increased. For example, if the robot touches a needle and the needle causes pain, then the needle object will have its powerpoints lowered. If the robot goes to a spa and the touch feeling is pleasurable then the spa object will have higher powerpoints.

Touch objects can also be wired to sexuality and the objects that cause pleasure or pain will have their powerpoints lowered or highered.

Taste objects

Taste is actually an object that is derived from the touch object. Sensors in your mouth is considered a touch object, but the mouth is only located in one local area. My guess is that the touch floater will store data regarding the taste of something in the mouth area. Taste will also have a linear range (it could be 3-d as well). The range for taste goes from very good to very bad. All other taste will fall between these ranges. Scientists speculate that there are 10,000 different taste senses. This means within the range from very good to very bad are 10,000 different taste senses.

Referring to FIG. 26, taste objects will also have built in pain and pleasure attached to the data. If the robot eats a rotten tomato, then the taste will be painful and the object, tomato, that caused the pain will have its powerpoints lowered. If the robot eats ice cream, then the taste will be pleasureable and the object, ice cream, that caused the pleasure will have its powerpoints increased.

Smell object

Smell object is just like taste in that it is derived for touch. The smell object also has a range or degree of smell. The range will go from very good to very bad. All the different smell objects will fall in between these two ranges. The smell object is the same as the taste object because it is a sensor and the most likely area it will be located is in the touch floater by the nose area.

Smell can also have built in pain or pleasure. When 5 sense objects are encountered that causes pain or pleasure, then that object will have its' powerpoints lowered or highered, depending on wither the robot is feeling pain or pleasure.

All 5 sense objects: visual objects, sound objects, touch objects, taste objects and smell objects will generate their own hidden data during runtime. These 5 sense objects are also used in pattern objects to assign meaning to words or sentences. The rules program will find the association and patterns between words/sentences and certain 5 sense object/s.

Hidden objects

In visual frames there are hidden data set up by the programmer that will provide additional information about a movie sequence. These hidden data are set up to establish additional data and allow the AI program to find patterns that can't be recognized by what is actually on the visual frames. Action words such as jump, walk, throw and run have patterns that can be identified by these hidden data. Also, patterned sentences from hidden data can provide meaning to object interaction. Below demonstrate patterned sentences. Object R1, R2, R3 can be anything.
1. R1 is on R2.
2. R1 is walking toward R2.
3. R2 is on R3 and R3 is on R1.
4. go around R1.
5. R1 is 3 feet from R2.
6. R1 is below R2.
7. R1 is under R2 but over R3.
8. R1 collided with R2.

The hidden data is wired to the visual frames. All the image layers or what is considered an image layer(visual object) will have measurements that provide the AI program with information about where that image layer is in relations to other image layers in the movie frames. The hidden data also provide information about the properties of the image layer such as the center point of the image layer and the overall pixel count.

Since the hidden data is wired to the visual object that means the learned object that is equal to the visual object has a reference to the hidden data. This is important because the AI program will use a combination of the three objects in order to find complex patterns and assign these complex patterns to sentences.

A note on hidden data, when the visual object (image layer) is forgotten, the hidden data still has the learned object. If both the visual object and the learned object are forgotten then the hidden data stands alone. “The hidden data can exist without either a learned object or a visual object or both”.

Hidden data contained in the visual frames:

Most of the hidden data are discussed in previous patent applications extensively so I'm going to do a review or a summary of these hidden data. These are the hidden data for visual objects or movie sequences:
1. Each image layer has a fixed frame size.
2. Each image layer has a normalization point (center point for that image).
3. Each image layer has a location point in the frame. The point is the normalization point.
4. Each image layer has focus area and eye distance.
5. Each image layer has an overall pixel count.
6. Each image layer has data that summarizes all the pixels that it occupies including pixel color, neutral pixel count, patterns in the pixels, 3-dimensional shape and so forth.

Image layer (or visual object) interaction from frame to frame:
1. Each image layer will have a direction of movement (north, south, east, west, northeast, southwest etc.). This can represent words such as north, south, east, direction, down, up, bottom etc.
2. Each image layer will have coordinate movement in terms of x and y from frame to frame. This can represent words like: moving, walking slowly, fast, slow, one step, stationary, taking a break and so forth. If this data is combined with the direction of movement then more words can be represented such as: moving south, jump, walk, throw, trajectory, the car took a nose dive into the water, the book fell, turn around, jump up, look down, move sideways and so forth.
3. Each image layer will have relationships to other image layers in the current pathway. The relationships will include the coordinate points between the two image layers and the direction between the two image layers.
4. Each image layer will have a touch sensor that lights up when it touches another image layer. This can represent words like: touch, collision, slide, skim, and so forth.
5. Each image layer will have a degree of change from one frame to the next. If it changes its shape dramatically it will be recorded. If it changes its shape gradually it will be recorded. This is important because if the image layer touches another image layer the degree of change will tell if the interaction caused the image object to change or it didn't cause the image object to change. A car accident definitely changes the way a car looks after the collision, while solid objects moving very slowly and colliding don't change its shape.
6. Each image layer will have scaling and rotation data. Did the image layer grow larger in size? Did the image layer rotate to the right? If it did what is the degree of rotation? Words such as: grow bigger, deflated, change its size, rotated, towards, move away from, and shrink can be represented by this data.

These are just some of the hidden data that will accompany visual images and movie sequences. The programmer can add in more data, but the Al program will take a longer time to find patterns among the hidden data. This is where the programmer should decide how much hidden data to include. Too much hidden data will overwhelm the system and too little will prevent the pattern function from doing its job properly.

Pattern objects

In prior art, discrete math and predicate calculus are used to represent language. Predefined iconic objects and are used to represent words and grammar structure in a limited environment. Assignment statements, if-then statements, or statements, and statements, not operators and so forth are used in combinations to represent language. They also classify sentences into one of these groups: facts, questions, answers, directed sentences, personal sentences, etc.

The human artificial intelligence program doesn't use any of the pre-existing AI techniques to represent language. The HAI program has built in internal functions such as the 3-d environment, long-term memory, hidden data, and so forth to find “patterns” and assign these patterns to language.

The 3-dimensional storage area contains all 4 data types: 5 sense objects, hidden objects, learned objects, pattern objects. 5 sense objects include: visual objects, sound objects, taste objects, smell objects, and touch objects. All these different data types are used to find patterns between similar pathways in memory. These pattern objects are important to assign meaning to words and sentences in a language.

Here are most of the internal functions used by the AI program to find meaning to language and predicting the future:

1. the assignment statement—the rules program determine the assign threshold. If two objects pass the assign threshold that means both objects are equal. Patterns are used to assign this function to a sentence.

2. modifying data in memory—This function changes the data in memory by inserting data, deleting data, modifying data, modify the powerpoints and priority of data, and migrating data from one part of memory to another part.

3. using the 4 different data types to find patterns. The 4 different data types are: 5 sense objects, hidden objects, learned objects, and pattern objects. The 5 sense objects contain: visual objects, sound objects, taste objects, touch objects, and smell objects. This function will use the 4 different data types as variables to find any patterns between similar pathways. These data types will be used to represent reference objects in patterns. These patterns will then be assigned to represent meaning to words or sentences.

4. determining the existence of an object in our environment. This function determines if objects in our environment currently exist or not. Objects like people, places, things situations, time and so forth can have one of three states: existing, non-existing or changed.

5. searching for data in memory—This function searches for and extract specific data from memory by using patterns that were found in similar examples. The AI program can extract data from linear sound, it can extract data from 2-dimensional visual movies, or any other 5 sense data.

6. determining the distance of data in the 3-d environment—finding the distances between two or more objects in memory is based on patterns. Measurements and distances between objects are analyzed and assigned to words and sentences.

7. rewinding and fast forwarding in long-term memory to find information—the length of when certain situations happen and where it happened is based on patterns. Information will also be extracted from the movie sequences.

8. determining the strength and weakness of data in memory. How strong is one data compared to another data and how the data changes during a time period depend greatly on patterns found in similar examples.

9. a combination of all internal functions mentioned above.

Below are just some of the patterns to represent different sentences. Words in sentences can mean: one object belongs to someone, one object is located at a certain location, one object is existing in our environment, one object is a part of another object, or one object is made from another object. Whatever the meaning is, regardless of how complex, the HAI program will be able to find the patterns and assign these patterns to words/sentences.

1. R1 has a R2

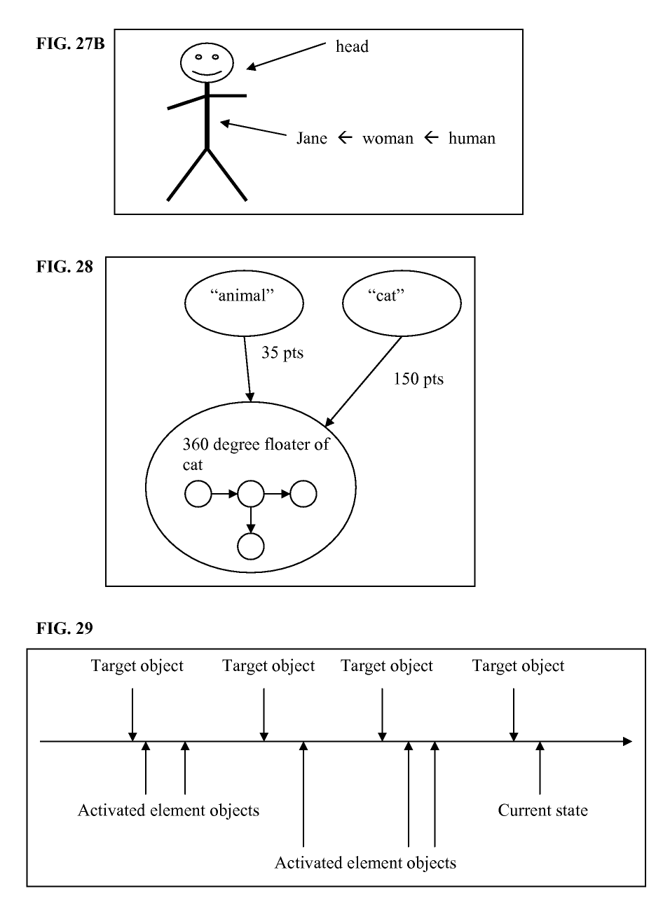

The AI program will use patterns within the 3-dimensional storage area to find the meaning to R1 has a R2. After the AI program compare similar pathways stored in memory a universal meaning will be assigned to this sentence structure. The pattern that resides in this sentence structure is the object R2 is an encapsulated object located in object R1. Dave has a head, Jane has a head, a car has a steering wheel, a bank has a volt, and a soda can has a cap. All these sentences have a universal meaning. The meaning is presented in the diagrams in FIGS. 27A and 27B.

Notice that the head is an image layer encapsulated within Jane or Dave. I show the reader the hierarchical groups that represent the human images. The AI program will look at the patterns of not only what that image is, but also, the hierarchical meaning of that image. For example, the group human can represent a child, a man, a woman, an old man, an old women, a girl child, a boy child, a handicapped man, a man in a wheelchair and so forth. The learned group women can represent any women image regardless of race, size, religion, shape and so forth. The AI program will find that the two examples (FIGS. 27A-27B) share a pattern: the head object is contained inside the human object.

The sentence structure “R1 has a R2” has a universal pattern. R1 and R2 can be any object, but the underline meaning of the sentence will stay the same. The AI program will find the universal pattern for all examples and it will understand the sentence regardless of what R1 and R2 are. If there exist multiple meaning to the sentence structure the AI program will find multiple meaning to the sentence. The conscious will tell the AI program what the real meaning is via activated sentences.

2. R1 has 4 R2

This sentence structure means the object R1 contains 4 objects of R2. For example, if the sentence is: a cat has 4 legs the pattern is the object cat comprises 4 object legs. This example is similar to the last sentence example.

Because 2-d images hide features on the object, the 3-d storage has data about an object from 360 degrees. The AI knows that a cat object has 4 legs, not from still pictures of the cat, but from the 360 degree floater of the cat. The floater of the cat contains every sequential image of a cat in all animated states.

This R1 has 4 R2 can be applied to all sentences that have that kind of configuration. Examples are listed below:
A cat has 4 legs
A dog has 4 legs
An animal has 4 legs
A table has 4 legs

The number 4 can also be a variable and can be any number. N1 will represent a given number. For example, R1 has N1 R2. Sentences that can be created from this structure are:
A man has 2 arms
A human has 1 head
A giraffe has 2 eyes
The picture has 2 animals

3. Five R1 are on the R2

This sentence structure is assigning certain images to words in the sentence. For example, if the sentence is “five animals are on the table”, this means that within the boundaries of the table object, encapsulates five animal objects. The word “on” also means that the animals are positioned on the table, most notably touching the surface of the table. If the word “on” is replaced with the word “under” that means the animals are positioned below the table, most notably on the ground, but within the confines of the table's 4 legs. The rules program will find the patterns to any sentence structure regardless of how complex they may be.

4. R1 is at the R2

In this sentence structure, the pattern is that the object R1 exist in or around object R2. If a teacher is teaching the robot that Melissa is at the kitchen, then the robot will find out that object Melissa is located within or near object kitchen. The approximate location of the two objects will be noted and the location of the two objects in relation to each other will be noted. Similar examples are compared and the AI program will average out all examples and output a universal meaning to the sentence structure: R1 is at the R2. Depending on what R1 and R2 are the AI program will have different meaning to the sentence structure. For example, the meaning of sentence, “Melissa is at the kitchen” is different from the meaning of sentence, “the book is at the library”. The relative location of each object is different.

5. The R1 is happening now

This sentence structure conveys an event that is happening now. All events, regardless of how complex, can be described in terms of language. Events represented by words/sentences can take the variable R1. Language can be used to classify any 5 sense data or a combination of 5 sense data. If the sentence is used, “the singing show is happening now”, and the robot looks at the television screen and sees the singing show, then it will know that there is a pattern. The pattern is that the singing show currently exists in our environment and the words in the sentence structure are trying to convey that meaning.

6. The R1 is happening in 2 minutes

This sentence structure is similar to the last example. The sentence includes a time that the event R1 will happen. Imagine the sentence, “the car accident is happening in 2 minutes”. The pattern is telling the AI program that from the current state, in approximately 2 minutes, the car accident will happen. If the AI program truly understands the sentence then it will know that in two minutes the car will turn into scrap metal. It will anticipate that the event will happen approximately 2 minutes into the future.

7. The color on the cat's face is blue

Different regions on an object can be focused on and certain characteristics can be extracted. In the case of the sentence above, the object is a cat. The sentence is trying to focus the robot's attention to the color on the cat's face. Since the color of the cat's face is the color blue, then that is what the sentence is trying to convey.

Different regions on 3-d objects have different colors. The colors can be gradual or scattered or mixed or layered and so forth. The pattern of colors arranged on specific regions on an object can be extracted based on intelligence.

Words/sentences can be used to show different color displays. If a dog has spots all over its body, the sentence, “the dog is grey with black spots all over its head”, describes what it looks like. If a cat has different rainbow colors on its body, the sentence, “the color of the cat is swirling with rainbow colors”, describes what it looks like. If someone wants a specific color on a specific region on the animal then the sentence, “the cat has a brown ring-like color on its' left ear”, will describe the animal.

8. The paper is made from trees

Other more complex sentences use the human conscious in order to find patterns. This sentence uses a form of logic to understand. Activated sentences regarding how certain objects are made will average itself out. For instance, simple visual images can't convey how paper is made from trees. However, we can use logical sentences to explain the process of how paper is made from trees. This paper example will be averaged out with other similar examples such as how apple juice is made from apples or how sound is made from speakers. Similar logical sentences combined with visual movie scenes can provide the AI with the necessary objects to find patterns to complicated words/sentences.

9. A cat is a form of animal

Referring to FIG. 28, the diagram shows that all 3 objects have the same meaning. Animal, cat, and the floater of a cat are the 3 objects. The pattern for the sentence, “a cat is a form of animal” is based on the fact that the learned groups animal and cat are assigned to the floater cat; and the word animal has less powerpoints then the word cat.

Hiearchical objects can be represented by this kind of pattern. The universal sentence “a R1 is a form of R2” can represent infinite possibilities. R1 and R2 can be any object. Sentences that can be constructed from this sentence structure are:
A human is a form of Mammal
A dog is a form of animal
A cow is a form of animal
A snake is a form of reptile
A reptile is a form of animal

10. The man is very tall

Adverbs and adjectives that describe a noun can be understood by a very sophisticated form of patterns. In current fuzzy logic topics, scientists try to solve problems such as understanding words like: a little tall, medium tall, very tall. The range of tallness is what they are trying to represent. The individual word tall is another factor. Depending on what the object tall is referencing, there are varying degrees of tallness. For example, an 8 year old boy can be 5′6″ and he can be considered tall for his age. However, if a 20 year old is 5═6″ he is considered short.

To solve the problem of understanding adverbs and adjectives in sentences, patterns are used. When we say things like: That boy is tall or that man is tall or that building is tall, the word “tall” is describing a noun. Tall is not one word that describes all objects (nouns), but is a word that can have multiple meaning for different objects. The key is to locate what the word tall is describing. If the word tall is describing a boy then there should be a range of what tall is regarding boys. If the word tall is describing a man then there should be a range of what tall is regarding men. If the word tall is describing a building then there should be a range of what tall is regarding buildings.

The word tall is describing the height of an object from the ground-up (for the most part). There are occasions where tallness is not about height, but width, or a combination of height and width. It really depends on the patterns found, but for the most part, the pattern found will be the height of the object.

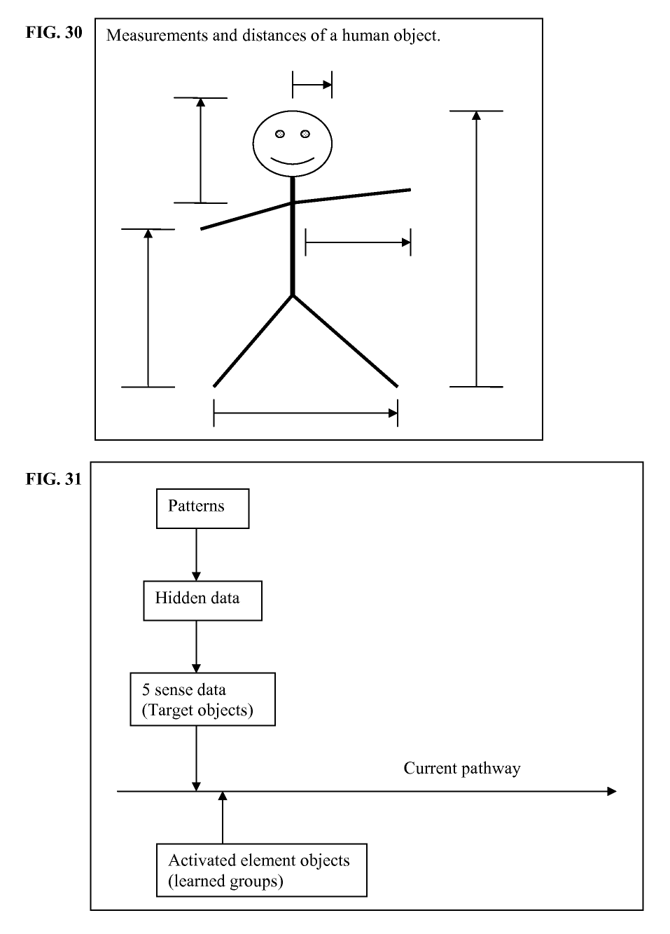

Referring to FIG. 30, factors and data used to describe the meaning to the word “tall” comes from the image layer of an object (objectA). All encapsulated objects in objectA will also be considered. The length of one encapsulated object is compared to the length of another encapsulated object. If the computer finds a pattern it will assign this pattern to an object. The rules program will bring this object closer to the pattern sentence: The R1 is very tall. For the tallness of a man, the length of the foot (encapsulated object) to the head (encapsulated object) will be used.

This technique is also used for adverbs such as: very, medium, small, big, large, little and so forth. Combination of words like: “very tall”, “average tall”, “a little tall”, can be used to find patterns instead of individual words.

The words “very tall” should not be viewed as one fixed object. If these two words were put into different sentences they can mean very different things. It really depends on the current situation and other objects surrounding the two words, “very tall”. For example, the sentence, “the boy is very tall”, very tall means the height of the boy in comparison to the average height of all boys. Another example is, “the building is very tall”. “Very tall”, in this sentence mean the average height of all buildings. The two words, “very tall” may have an average meaning for all sentences that contain the two words, but to have a more defined meaning, the two words have to be understood in terms of the entire sentence and the current environment.

11. If-then statement, and-statement, and not-statement

The existence of an object is crucial to understanding something like an and-statement. If the pattern sentence is “R1 and R2”, then after repeatedly training many examples with this sentence structure a universal meaning will be revealed. That meaning is that object R1 is existing along with object R2. For example, if the robot sees someone holding a pencil and an eraser and the sentence is encountered: I am holding the pencil and the eraser, then there should be a pattern to this situation. Another example is: the dog and the cat are in the picture. The fact that the dog and the cat are existing in the picture tells the robot that the word “and” is a grouping of two existing objects in a given environment. In this case the environment is the picture. R1 is the dog and R2 is the cat.

If-statements are existence of objects or events based on a probability. “If dave presses the red button then the sky will turn blue”. If this sentence is encountered along with the situation, then the robot will understand that certain parts of the sentence is a condition part and the other part is an event. If the robot encounters this if-then statement 5 times and 2 out of 5 times the sky turns blue when dave presses the red button, then that means there is a 2 in 5 chance that the if-statement: “if dave presses the red button” will lead to the event: “then the sky will turn blue”. Dave presses the red button is existing in the environment and the next existing event is: the sky will turn blue. The probability of the two existing events will happen 2 out of 5 times. All if-then statements will depend on their individual situation and what kind of objects are involved.

The not-statement is the non-existence of an object. After many examples the robot will learn that the pattern “not R1” is the non-existing of object R1. If the sentence was encountered: dave is not here. The robot looks around and dave doesn't exist—the robot can't find dave. The robot will associate that meaning with the sentence and understand what “not” means.

Representing language in terms of fuzzy logic

The next couple of sections will emphasize on the robot's conscious and how the conscious is used to solve problems, plan tasks, predict the future and so forth. These sections were left out from my last patent application and I wanted to include them here so the readers can have a better understanding of how human intelligence is produced in a machine.

The human conscious works by the following steps:
1. The AI program receives 5 sense data from the environment.
2. Objects recognized by the AI program are called target objects and element objects are objects in memory that have strong association to the target object.
3. The AI program will collect all element objects from all target objects and determine which element objects to activate.
4. All element objects will compete with one another to be activated and the strongest element object/s will be activated.
5. These activated element objects will be in the form of words, sentences, images, or instructions to guide the AI program to do one of the following: provide meaning to language, solve problems, plan tasks, solve interruption of tasks, predict the future, think, or analyze a situation.
6. The activated element object/s is also known as the robot's conscious.

FIG. 29 shows an illustration of target objects and activated element objects. As the AI program recognizes target objects in memory it will activate element objects. If the target object and the activated element object are equal, then the activated element object is a learned object of the target object.

Representing language in terms of fuzzy logic

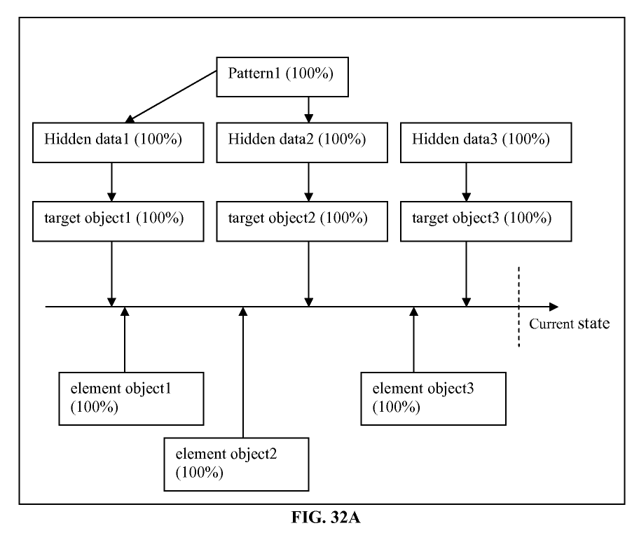

Referring to FIG. 31, all 4 different data types and their encapsulated trees will be used to match pathways in memory (5 sense objects, hidden objects, learned objects or activated element objects, and pattern objects). This is how language can be represented in terms of fuzzy logic. Same sentences from different languages can look totally different, but the meaning is the same. The target objects are the sentences encountered and the activated element objects are the meaning. Different sentences in English looks different, but they mean the same things. The three sentences below is one example.
1. “look left, right, and make sure there are no cars before crossing the street”
2. “remember to see if there are no cars from the left and right before you cross the street”
3. “don't forget to look at all corners to make sure there are no cars before crossing the street”

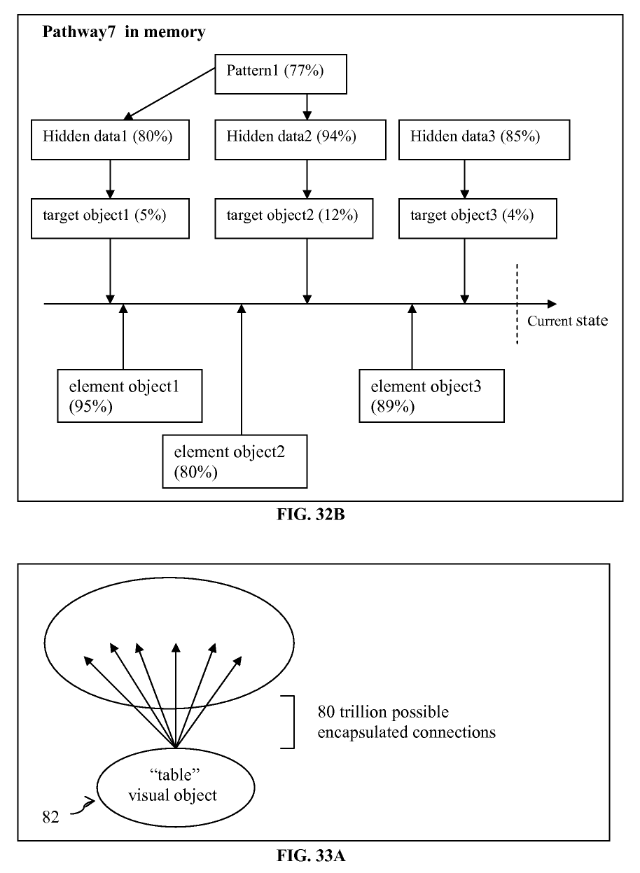

Visual text words and sound words can be deceiving because different sentences, even with a slight variation, can mean totally different things. The meaning of the sentences can be the same or similar. This is why the AI program will compare all 4 data types: 5 sense data, hidden data, learned groups, and patterns. The diagrams In FIG. 32A and 32B demonstrates how the robot compares pathways in memory.

The current pathway is the input from the environment. The AI program will compare the current pathway with pathways in memory based on all 4 data types. It will lock onto each data type and find the closest matches (finding a perfect match is very rare). Pathway7 is a pathway stored in memory. In FIG. 32A, all the data types in the current pathway are set at 100%. In FIG. 32B, the percent next to the data types in pathway7 is the match percent it has with the current pathway.

Imagine if the target objects were visual text words. The AI program is reading in sequential text words from a book. Notice that the target object match percents are very low, however the element objects that these text words activated have very high match percents. If target objects in the current pathway and pathway7 are:
Current pathway: “look left, right, and make sure there are no cars before crossing the street”
Pathway7: “remember to see if there are no cars from the left and right before you cross the street”

These two sentences don't look the same, but the meaning is the same or similar (the meaning is the activated element objects). The pattern objects and hidden objects also have similar matches. In fact, the meaning is almost exactly the same. This is how the AI program represents language in terms of fuzzy logic.

Optimize search by using all 4 data types to search for information The present invention is novel because it contains one of the fastest search algorithms in computer science. Human beings are intelligent because they are able to learn language and use language to search for and organize data in memory. Instead of searching for information using only 5 sense objects (visual objects, sound objects, taste objects, smell objects and touch objects) learned objects can be used to search for information even faster.

Learned objects are two or more objects that have very strong association with one another. The connections are so strong that they are grouped together in an equals ring. All objects inside an equals ring are considered the same exact object. Visual objects are grouped together in terms of object floaters. These object floaters are assigned to words or sentences to mean something. For example, the words “cat” means any sequential image of the cat floater.

When a visual object is stored in memory, if a learned object is activated and the learned object is the same object as said visual object, then both learned object and visual object will be stored in the same area. When the AI searches for information the learned object will identify the visual object and vice versa because they are the same exact objects.

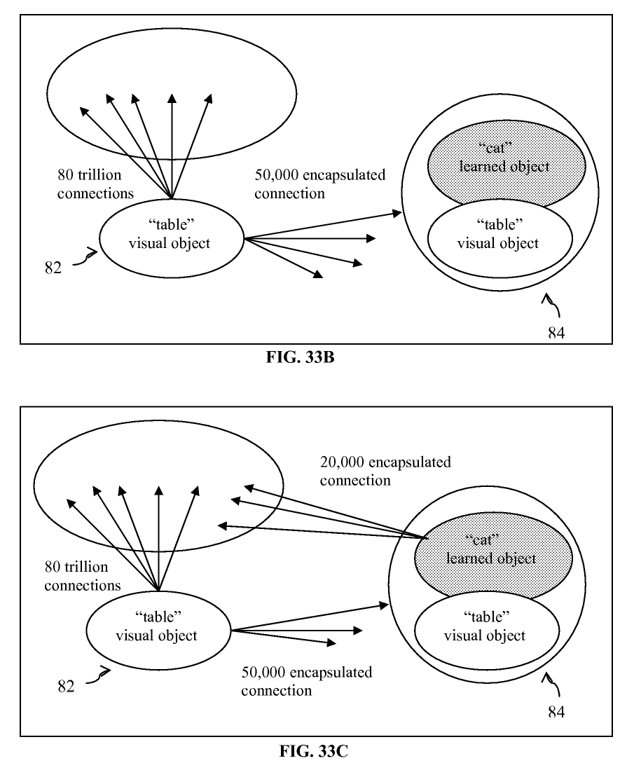

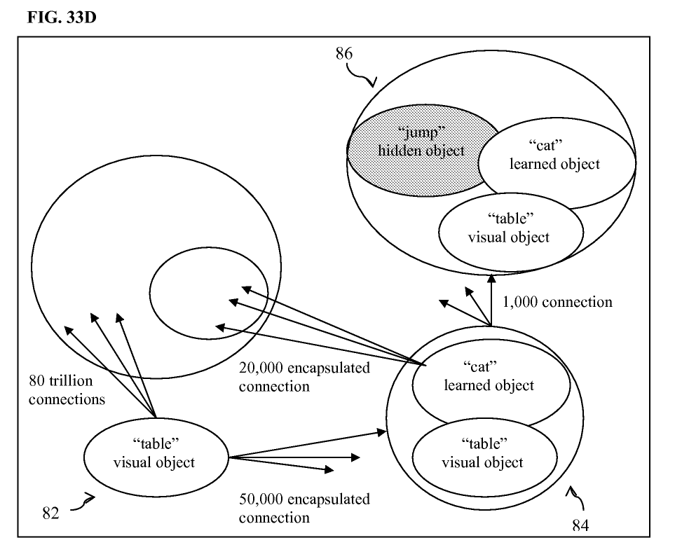

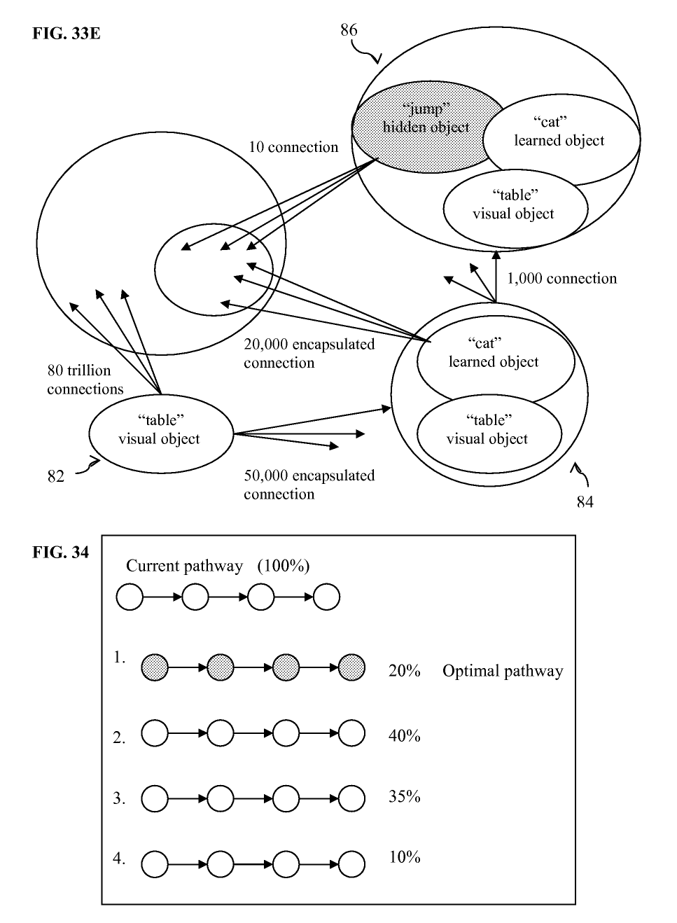

In FIG. 33A is a diagram depicting the searching of data using only visual objects. Imagine if there are 80 trillion encapsulated connections to travel on to get to the next visual object, the search function will narrow down the search by traveling on the strongest encapsulated connections first. Even with this method searching for data in 80 trillion next encapsulated connections is like searching for a needle in a hay stack. Using only visual objects to search for information will not work when dealing with very large scale problems.

The novel approach covered in this invention is to use 4 different data types to search for information: 5 sense objects, hidden objects, learned objects, and pattern objects. All 4 data types have their own encapsulated connections and all 4 data types can be grouped together in combinations and permutations.

FIG. 33B is a diagram depicting the searching of data using both visual objects and learned objects. Imagine if you were looking for a visual object of a cat jumping over a table. In the diagram, visual object “table” 82 has already been located by the AI program. The next step is the find the image of a cat jumping over the table. If we use the encapsulated connection for visual objects only, there will be 80 trillion connections we have to search.

Referring to FIG. 33B, visual object “table” 82 is grouped together with the learned object “cat”, by following the group 84 that has both visual object “table” and the learned group “cat”, we can search for the cat images faster. Imagine that the encapsulated connections for the learned objects is 50,000, that means we only need to search a maximum of 50,000 to get to the encapsulated object (“table”, “cat”) 84. If you search for the learned object by searching the strongest encapsulated connections first then the search will be much faster.

Referring to FIG. 33C, the learned object has a reference to the visual object “cat”, all the sequential images of a cat is grouped in the cat floater and the learned object “cat” has a reference pointer to this cat floater. By following the learned object “cat” the search has been narrowed down to 50,000. Imagine that the learned object “cat” has reference pointers to 20,000 sequential cat images. This means that the search function has now narrowed down the maximum search possibility to 70,000. Searching for a visual object in 70,000 entries is faster than searching for a visual object in 80 trillion entries.

To narrow down the search even more I introduce hidden objects to the search. When visual objects move from one frame to the next in a movie sequence it generates hidden objects. That hidden object is attached to the visual object. In FIG. 33D, when the cat jumped in the movie sequence it generated a hidden object. That hidden object is now used to search for information along with the learned object and the visual object. From (“table”, “cat”) 84 the encapsulated connection for hidden object is 1,000. That means it takes a maximum of 1,000 searches to get to (“jump”, “table”, “cat”) 86. If you add up the maximum number of searches it will add up to 51,000. Referring to FIG. 33E, imagine that the hidden object has a reference pointer to 10 sequential images in the cat floater, that means we have narrowed down the possibility of 20,000 images in the cat floater to 10 images. The final maximum search required to find the visual object cat jumping over a table is 51,010.

More on the human conscious

This section will provide more examples on reasoning and the conscious. Up to this point the lessons taught about the conscious is very basic. In real life the conscious is very complex and there are many forms of consciousness that are not discussed yet. Hopefully, by the time the reader finishes reading this section they will have a better understanding of other factors that matter in terms of how human robots think.

Conscious thought with little or nothing to do with the 5 senses

There are times when the robot will take in a small amount of data from the environment and use that to activate sentences (conscious thoughts). For example, if the robot was catching the bus to work and is bored, it will start to think. It will cut off the senses coming from the environment and simply jump and travel on different pathways in memory. Those activated element objects has nothing to do with the environment. The only thing that was focused on was the word: “bored”. This word then activated thoughts in the robot's mind without any relations to the environment.

The conscious doesn't use all of its data from the 5 senses to come up with thoughts, but it filters out the 5 senses to focus on the most important data. Focusing on what data from the environment is important is a learned thing. Learning to think based on focused data from the environment is also a learned thing.

The robot learns meaning to sentences and these sentences have patterns that manipulate pathways in memory—the sentences modify pathways, organize pathways, search for pathways, delete pathways, insert pathways, modify the strength of the pathways and so forth.

For example, if a teacher thought the robot: when you are bored, think of something to do. Based on this sentence the robot will store this information in memory for future use. When the robot encounters a situation where it is bored such as staying home with nothing to do, then it will activate this sentence: “think of something to do”. This sentence essentially instructs the robot “to do something”. The sentence “think of something to do” is actually a search pattern to find pathways in memory based on things the robot sensed several hours ago, or several days ago. The instructions are not fixed and have many variations depending on the current environment or data that was sensed in the past.

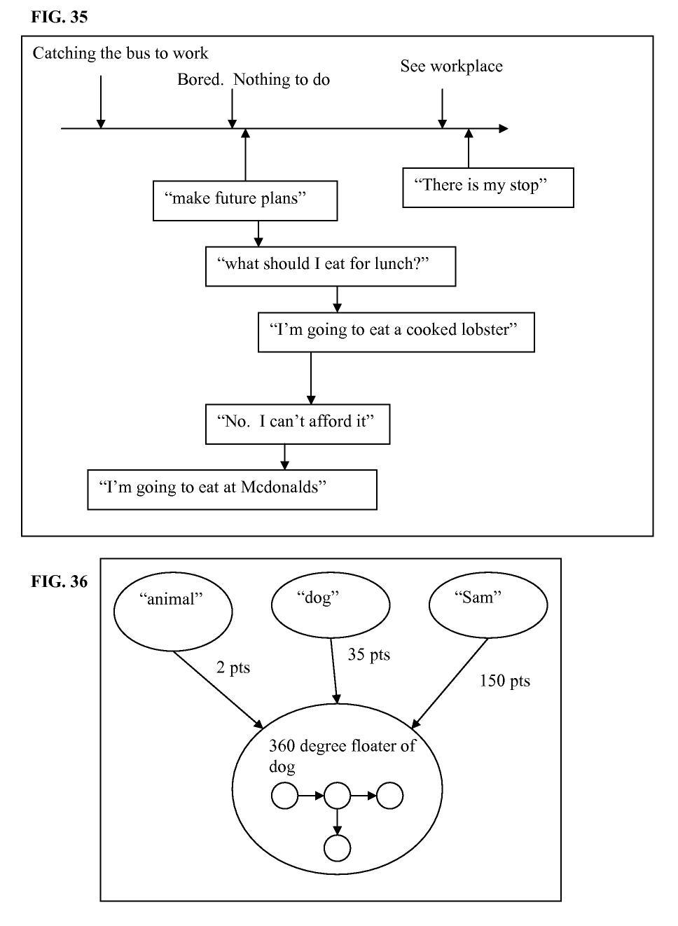

Referring to FIG. 35, another example is, if a teacher thought the robot: when you have nothing to do, make future plans. When the robot is catching the bus to work and has nothing to do, it will activate the sentence: “make future plans”. The next response from this statement is based on a pattern. There are no fixed responses or no fixed sentences based on the sentence “make future plans”. The next response will depend on what the environment is at the moment and what kind of information did the robot sense in the last few hours, or last few days. The next response can be anything.

The word “think”, if understood by the robot, can be used to control itself. Sentences can be thought to the robot by teachers in terms of the word think. Sentences like:
1. think about the problem
2. use your mind to think of a solution
3. solve the problem by thinking of a way to solve the problem
4. think of the image
5. think of the sound
6. he is thinking of a house
7. think of how far the distance is from the supermarket to the library

The AI program will find patterns between the thought process of the machine and the meaning of each sentence. These sentences are then used as patterns to control the machine to think in a certain way. Thinking is actually just pathways in memory with specific patterns.

“Think of a cat image”, for example, means the robot has to locate the object cat in memory and activate one image of a cat. “Think of a logical solution to the problem”, means that the robot has to use data from memory and certain objects from the environment to solve a problem. “What are you thinking about”, means that the robot has to say what was on his mind before the question was asked. He must look at short-term memory to find what was activated in memory based on the environment and use these activated pathways to answer the question.

Learning to focus on an object in the environment is thought by teachers and these lessons guide the robot to focus on certain objects. Despite the countless objects that the robot senses from the environment it is able to filter out the objects that are most important. This process is done by one of the deviation functions: minus layers from the pathway. The focus of the object is the priority of the object. In the decision making process, the robot has to decide based on many pathway layers. All the data from the environment are broken up and searched in memory. The combinations and permutations of all data experienced from the environment are searched and ranked (the AI will undoubtedly search for the strongest combinations and permutations). The highest ranking pathway layer will be considered the optimal pathway.

Referring to FIG. 34, the diagram demonstrates that sometimes a higher percent match in memory doesn't necessarily mean it will be picked. Many factors are included in the decision making process. However, for the most part the best match is usually the optimal pathway.

Deep conscious thoughts

When objects from the environment are encountered by the AI program, those objects will become stronger. If these objects (element objects) happen to be in the rules program, they will have a better chance of being activated. Things that happen in the last few minutes, or hours, or days, or weeks will have a better chance of being activated by the robot's conscious.

Let's use Bill Clinton as an example. The most famous memory anyone has of Bill Clinton is the sex scandal that happened in the late 90's. Well, at least for me, but for the most part, the majority of people will associate Bill Clinton with Monica Lewinsky. If I saw Bill Clinton on TV talking about global warming then global warming will be the strongest associated object to Bill Clinton at that current moment. During minutes, days, weeks and even months after I see Bill Clinton talk about global warming my mind modified the object Bill Clinton and its associated objects. My mind assigned Bill Clinton with global warming as the strongest associated object (Monica Lewinsky, now, becomes the second strongest associated object). The next time I see Bill Clinton on TV, global warming will be the first associated object to activate. As time passes, global warming will lose its association to Bill Clinton and sex scandal will again dominate. Unless my mind encounters more scenes of Bill Clinton and global warming, the associated connection between the two objects will lose its strength.

These recent past 5 sense data are important because reasoning and conscious thoughts use the most recent data encountered by the AI program. The patterns in pathways might use data that happened 5 days ago or 3 minutes ago, or even 1 month ago. It varies depending on the pattern.

Stereotypes of an object such as the Bill Clinton example shows how recently encountered associated objects has a more likely chance of being activated than associated objects that were encountered a long time ago. It really depends on how strong associated objects are and how important the robot associate two objects. Sex scandal is a very powerful memory while global warming is a weak memory. This means that the association between Bill Clinton and global warming is just temporary; and eventually people will forget Clinton ever gave a speech about global warming.

Logic and reasoning to solve difficult problems will activate recent knowledge instead of knowledge learned many years ago. Again, this can vary because a knowledge can be trained many times so that it can have a permanent location in memory. Doing basic addition and subtraction are permanent knowledge because we have encountered these problems so many times. On the other hand, reading knowledge from a science book a few days ago is considered recent knowledge. These recent knowledge will activate in the mind when the time is needed to solve a particular problem. As time passes, that knowledge if not retrained will be forgotten.

Conflicting facts about a subject matter can be solved through the conscious as well. If we learned a fact many times in the past we tend to use that fact. But, if we encounter a new fact that contradicts an old fact we have to use either logic or a form of conscious thought to guide us to choose between the two. For example, if I was thought that the world is flat by many people in the past; and just recently I read in a magazine that the world is actually round, will I believe the world is flat or round? All of this stems from my intelligence and past experiences. If the scientist who claims the world is round backs up his claims with strong and concrete facts then I will believe him. Otherwise, I will believe what the majority of society believes. Even though the old fact is very strong, patterns from sentences allow me to forget that old fact and replace it with a new fact. The new fact was only encountered once, but because of specific sentences I was able to delete the old fact and insert the new fact in memory.

This will allow the AI program to adapt to the environment, not based on how many times data is encountered, but by assigning patterns to sentences and using the sentences to modify data in memory. These sentences can instruct the robot to insert new data, delete data, modify data, change the strength of the data, change the priority of the data or group data. Logic in terms of activated sentences will tell the robot what kinds of data to modify in memory.

Facial expressions and conversations

Again, words and sentences can describe how people feel. The conscious tells the robot what is going on in the environment. Even though the images on a person's face are small the images can convey different facial expressions. Simple movements of the eye brows or lips or eye position convey a different facial expression. The way that the robot learns these facial expressions is through a teacher who uses sentences, movie sequences, or diagrams to explain what a person is feeling at that moment.

The more we learn about a situation the more we understand it and the small things that make up that situation will be noticed. This is why, even though the face looks the same under any expression, we understand what the person is feeling based on certain minor facial movements.

This idea is important to better understand how humans engage in conversations. The conversations we have with people are not based on what the next best sentence is, but it is based on a very complicated form of consciousness. Previously learned lessons from teachers pop up in the robot's mind to guide it to say things to people. The robot will analyze the person's face, analyze the person's conversation and analyze the environment. Based on all these analytical data the robot's conscious will activate, in the mind, lessons learned by teachers. These lessons guide the robot to have a conversation.

When the robot takes in all these analyzed data, it will filter out some data and prioritize other data. Based on all the possible matches found in memory the robot will pick one optimal pathway. In addition to the 5 senses, the hidden data, and the activated elements objects, the robot will also consider the patterns between all the data sensed. This means that within all the words spoken by the person, and within all the objects in the environment, and within all the events the robot has experienced in the last few hours, there might be a strong pattern or relationship between certain data sensed.

As usual, the conversation the robot makes will be based on the average of what it learned. This would include: the lessons learned by teachers to have a conversation, the trial and error conversations the robot had, the copying of conversations on TV or real life. Most of the conversations that humans tend to have are predictable because we understand what society view as normal conversation or abnormal conversation. But, there are some people, based on their own experiences, say wrong things during a conversation. They either say the wrong things because they want attention from people or they say the wrong things because of poor judgment (random happenstance can also be considered poor judgment).

Encapsulation of objects within another object

A human being has thousands of encapsulated objects. Things that make up a human being such as a head, two arms, hand, legs, feet, chest, back, knee, eyes, nose, toes, hips, neck, shoulder and so forth are encapsulated objects.

When we focus on a human being, we tend to focus on the face. Why? Because the face has higher priority than any other encapsulated object in a human being. People can focus on the neck or leg or arm, but why do human beings focus their attention on the face? The reason why is because of two factors: (1) innately we humans (or animals) focus on things that get our attention. Noises made by the human being come from the face. When a human being talks we tend to focus our attention on the face. (2) teachers teach us to focus our attention on the face.

The majority of animals will focus on the face when they stare at a human being. Although they occasionally move their eyes in different areas, innately, they focus on the face. They were never taught how to behave or what to look at when they encounter certain creatures. There behavior is mostly governed by innate abilities.

Built in abilities is one factor that focuses our attention on the face. The 5 senses have built in abilities to focus our mind on things that get our attention. Loud noises, the object that is making the noise, moving objects, pain/pleasure, beautiful/ugly things, abnormal things and so forth are just some of the things in our environment that get our attention.

In human behavior we look at the face because we were thought to look at the face when we encounter a human being. Teachers teach us that we should always look at the persons' eyes when we speak to them. The lessons given by the teachers guide us in terms of behavior and how the body should act in a given situation. Back in the days of slavery, slaves were thought to look down at the ground when they encounter their master. This is why they don't stare at the face when talking to a human being.

The example given above shows that in any given object, their respective encapsulated objects matter in terms of what we remember about that object and what we focus on when we encounter that object. Each encapsulated object has a priority in terms of how important it is in the overall object. The reason why we activate faces to identify human objects is because that is the most important encapsulated object in a human object. We don't identify a human being by their feet or palm, or waist, but by their face. Of course, this can vary from person to person depending on how an individual was taught. And there are encapsulated objects, besides the face, that we use to identify people. Things like clothing, pants, upper body and so forth. But for the most part we identify people by their face.

Despite how similar faces can be, the more faces we encounter the more details of the face we can store and the more unique each face become.

Representing pronouns in language

Pronouns such as I, her, him, answer, they, and us are objects that are represented by the conscious. The meanings to these pronouns are assigned by conscious thoughts. For example, if you are reading a book and there is a word: “I”, that word isn't representing you, but it is representing a character in the book. The conscious will activate element objects in the form of sentences (or meaning of sentences) to tell the robot what the word “I” is in the book. In the book, if the king is speaking then the conscious will say: “the word “I”is referring to the king”.

In a math problem the word “answer” is a variable that will be assigned a meaning during runtime. If you're doing one math problem the answer can be 14 and if you're doing another math problem the answer can be 45. The conscious will tell you what the answer is during runtime. The method in which the conscious assign an object to an answer comes from math teachers. Their collective knowledge has been averaged out and the conscious will tell you what the answer is in the form of sentences (or meaning of sentences).

Identifying objects will depend on the current environment

When we identify people we have to say words to get their attention. Identifying people, places and things will depend on what the environment is at that moment in time. There can be multiple names to identify an object. For example, a dog can be called an animal, dog, or a specific name like Sam. Referring to FIG. 36, the powerpoints in the diagram represent how strong each name is assigned to the dog floater. Family members that own the dog calls the dog, “Sam”. Sometimes they call the dog, “dog”. And under rare conditions family members call the dog, “animal”.

The strongest identification, Sam, will most likely activate when the robot encounters the dog. However, there are rare occasions where it will activate the identity with the lowest powerpoints or medium powerpoints. It really depends on the current situation. If the robot is having a conversation with someone on the phone and this someone doesn't know the dog, then the robot might address the dog as: “dog”. On the other hand, if the robot is talking to a family member then the robot can use the name, Sam. A final example is if the robot is mad at the dog and it wants to call the dog in a derogatory way, then it can use the name, “animal”. As you can see from all the examples given, the identity of an object really depends on the current environment. Many factors are used to determine what an object is called.

Learning a new language

The robot can learn two or more languages at once. However, let's say that the robot is dominant in one language, English. How is the robot going to learn a second or third language? The answer is through patterns in words and sentences. If the robot wanted to learn Chinese, it must understand that one word in English can mean one character in Chinese. A grammar structure in English can mean a grammar structure in Chinese. English is read one letter at a time from left to right while Chinese is read one character at a time from top to bottom. By understanding all these tricks the pathways simply contain patterns to assign one object to another object in memory. In this case, one word in English (object) to one character in Chinese (second object).

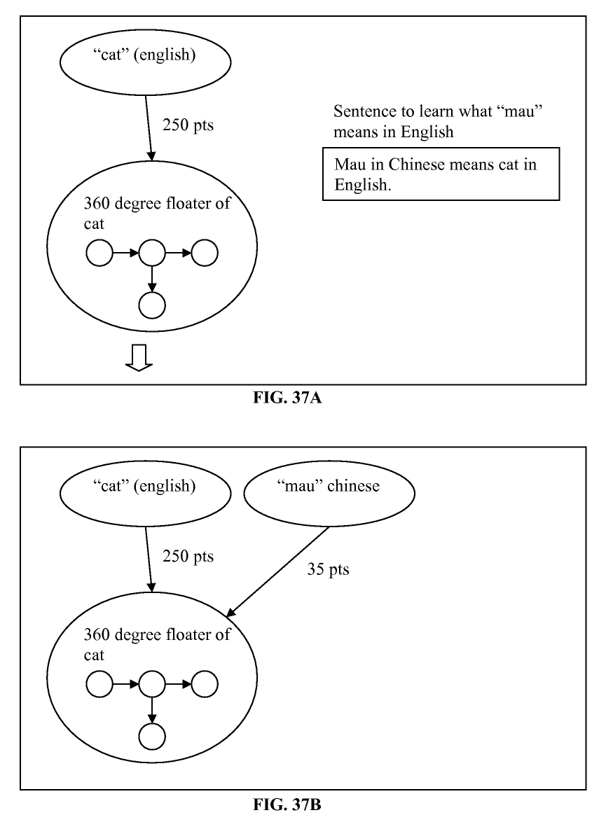

Referring to FIGS. 37A-37B, the patterns in words/sentences will create the object “mau” and put it close to the object “cat” so that when the robot recognizes the Chinese character, “mau”, it will activate the equivalent English word, “cat” . In the initial training phase, the robot should elicit this type of conscious thought. However, as time passes the robot, when recognizing a Chinese character, should activate the meaning to the English word and not the English word.

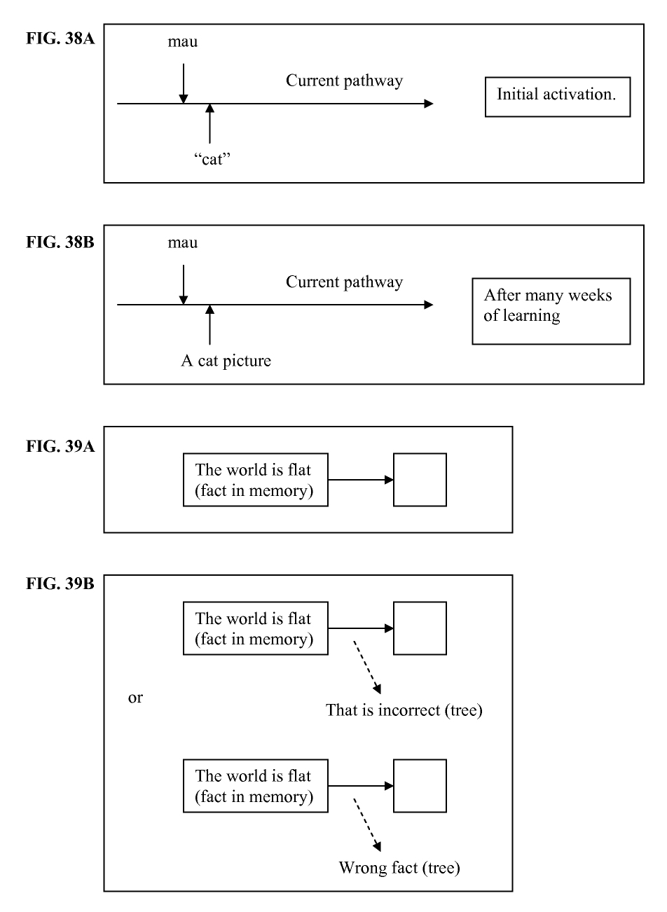

Referring to FIGS. 38A-38B, in the initial stages of learning a word in Chinese, the equivalent word in English will be activated. As the AI averages data from memory, the word mau will be closer and closer to the meaning of the English word cat. The meaning is the visual cat floater. As this learning continues the association connection between the word mau and the cat floater gets stronger and stronger. This will give the robot the ability to activate one image from the cat floater. Just like how the word cat activates a cat image, the word mau will elicit the same response.

This is a fairly easy example. Understanding grammar structures and understanding complex forms of words/sentences will work the same way. It all comes down to bringing the words/sentences of the new language to the language that is understood by the robot and forcing the new language to point to the same meaning. Once the new language establishes meaning, understanding said new language will be accomplished.

Storing facts and changing facts via words/sentences

“The world is round”, “5+5 equals 10”, “the current president of the United States is George Bush”, “the first president of the United States is George Washington”, “HI stands for Hawaii”, “there are 50 states in the United States”. All these sentences are facts and are stored in memory the same way that other sentences (questions, statements, etc) are stored.

In current database mining, facts are modified manually by having an expert programmer insert, modify, and delete facts from a database. In my AI program, words/sentences are used to insert, modify and delete facts from memory. Changing a particular fact is based on a pattern. Sentences contain patterns that will insert, modify and delete specific words from facts (sentences).

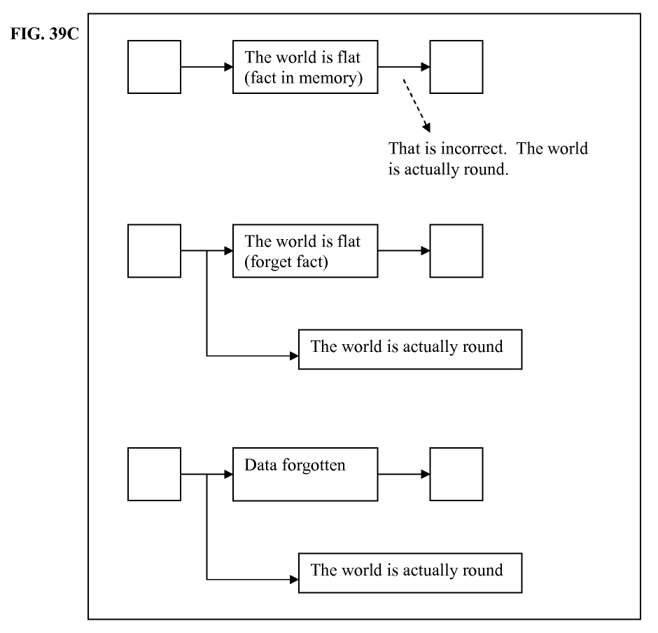

For example, if someone told me a false fact such as: “the world is flat”. This false fact is learned many times in the past so the data becomes very strong (FIG. 39A). There must exist a way to change the fact so that the robot can delete the false fact and insert the correct fact in its place. Before moving on I have to talk about forgetting information.

There is no such thing as deleting data from memory. Data can only be forgotten. So, if the robot wants to delete data from memory, all it has to do is decrease the strength of the false data so that eventually the false data is forgotten. We can also put a reminder on the false data, in the form of a sentence, telling the robot that the correct data is actually located somewhere else.

Referring to FIG. 39B, if someone say things like: that is the wrong answer or that is incorrect, we are actually storing that sentence in certain pathways. These sentences tell us that certain facts in memory are wrong and these sentences guide us to search for the correct facts. At the same time that this is happening the AI will attempt to look for any patterns. If any pattern is found between similar examples then it will be stored in the pathways.

Referring to 39C, as you can see from the diagram, the words, “that is incorrect” has a pattern that instructs the robot to forget the false fact, and to establish a connection with the correct fact. Over time the false fact will be forgotten and the connection is pointed to the correct fact.

This is just an easy example to show how the mind modifies facts from memory. The opposite function can happen, which is to strengthen data in memory. Words like: remember, don't forget, concentrate and so forth are words that tell the robot that certain facts must be strengthened.

Pain and pleasure can also be a factor to determine what is the right answer and what is the wrong answer. If the robot is doing something wrong and the teacher slaps the robot on the hand and says, don't! in a harsh manner, then the robot will put negative points on the word, “don't”. And when the robot does something and it's done correctly the robot gets rewarded and the teacher will say, “that's correct”. Now, the sentence, “that is correct” will have positive points. Learning something will then be governed by words that are used that tell the robot it is doing something good or bad. The robot will pick the pathway that leads to pleasure and stay away from pathways that lead to pain. This method can also be combined with the lesson above.

(extra note) The present invention is my artwork. 6 years has been invested in designing the human artificial intelligence program. The material in this patent and a chain of parent patent applications describe in detail the processes and functions that make up the HAI program.

The foregoing has outlined, in general, the physical aspects of the invention and is to serve as an aid to better understanding the intended use and application of the invention. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

What is claimed is:

1. A method of creating human artificial intelligence in machines and computer based software applications, the method comprising:
(a) an artificial intelligent computer program repeats itself in a single for-loop to:
(i) receive input from the environment based on the 5 senses called the current pathway,
(ii) use an image processor to dissect said current pathway into sections called partial data,
(iii) generate an initial encapsulated tree for said current pathway; and prepare variations to be searched,
(iv) average all data in said initial encapsulated tree for said current pathway,
(v) execute two search functions, one using breadth-first search algorithm and the other using depth-first search algorithm,
(vi) target objects found in memory will have their element objects extracted and all element objects from all said target objects will compete to activate in said artificial intelligent program's mind,
(vii) find best pathway matches,
(viii) find best future pathway from said best pathway matches and calculate an optimal pathway,
(ix) store said current pathway and its' said initial encapsulated tree in said optimal pathway, said current pathway comprising 4 different data types: 5 sense objects, hidden objects, learned objects, and pattern objects,
(x) follow future instructions of said optimal pathway,
(xi) universalize pathways or data in said optimal pathway; and
(xii) repeat said for-loop from the beginning;
(b) a storage area to store all data received by said artificial intelligent program; and
(c) a long-term memory used by said artificial intelligent program.

2. A method of claim 1, wherein said image processor generates an initial encapsulated tree for said current pathway by dissecting and grouping the current pathway into an encapsulated tree using 5 dissection functions, comprising:
(a) dissect image layers that are moving,
(b) dissect image layers that are partially moving,
(c) dissect image layers by calculating the 3-dimensional shape of all image layers in the movie sequence,
(d) dissect image layers by calculating dominant color regions using recursion,
(e) dissect image layers using associated rules;
wherein, elements in said initial encapsulated tree are called visual objects.

3. A method of claim 2, in which each visual object comprises:
(a) a frame sequence with at least one frame;
(b) three variables, comprising:
(i) average pixel color,
(ii) average total pixel count,
(iii) average normalized point;
(c) priority percent;
(d) powerpoints;
(e) existence state;
(f) child encapsulated links;
(g) parent encapsulated links;
(h) domain number;
(i) search data.

4. A method of claim 1, wherein said averaging data from said initial encapsulated tree is accomplished by calculating the average of all variables in each visual object; and designating an existence state of each visual object from one frame to the next with one of the following: existing, non-existing, and changed.

5. A method of claim 4, wherein said averaging data for a variable in each visual object comprises the steps of: adding up all child node's said variable value, times the result by said variable's importance percent, dividing the result with the number of child nodes, times the result by said visual object's priority percent, and times the result by factorial 0.2.

6. A method of claim 1, in which said search function searches for said initial encapsulated tree for said current pathway and compares the data with memory encapsulated trees or pathways in memory, wherein elements in said initial encapsulated tree are called visual objects and elements in said memory encapsulated trees are called memory objects.

7. A method of claim 6, wherein said search function searches for said initial encapsulated tree or current pathway by allocating search points and guess points to certain search areas in memory, comprising two functions:
(a) a first search function uses search points to match a visual object to a memory object and uses breadth-first search, whereby it searches for visual objects in said initial encapsulated tree from the top-down and searches for all child visual objects before moving on to the next level;
(b) a second search function uses guess points to match a memory object to a visual object, uses depth-first search to find matches, and the search steps comprises:
(i) from a memory object match in memory the search function will travel on the strongest-closest memory encapsulated connections to find possible memory objects,
(ii) certain criterias determine which memory objects will be used to match with possible visual objects in said initial encapsulated tree,
(iii) when a memory object is picked, match with visual objects in said initial encapsulated tree and output a match percent.

8. A method of claim 7, wherein said certain criterias to determine which memory object to pick, comprises:
(a) the stronger the memory encapsulated connections leading to the memory object are the better chance it will be picked,
(b) the stronger the powerpoints of the memory object is the better chance it will be picked.

9. A method of claim 7, wherein said guess points will combine visual objects in initial encapsulated tree and match to memory objects, and said guest points also spot discrepancies between said initial encapsulated tree and memory encapsulated trees.

10. A method of claim 7, wherein second search function will follow the general search areas outputted by the first search function; in the case said second search function deviates from the general search area, each guess point deviated will stop, backtrack, try alternative searches, and wait for further search areas from said first search function.

11. A method of claim 9, wherein reorganization occurs when the search function finds discrepancies between the structure of said initial encapsulated tree and an encapsulated tree in memory, and when it is determined that certain visual objects in said initial encapsulated tree is flawed, then said initial encapsulated tree will be modified, said modified by changing the structure of said initial encapsulated tree to the encapsulated tree in memory only in the discrepancy area.

12. A method of claim 11, wherein said discrepancies occurs when child visual objects share different parent visual objects between said initial encapsulated tree and the encapsulated tree in memory, said re-organization occurs to modify pixels in visual objects in said initial encapsulated tree.

13. A method of claim 7, wherein said search function designates search points or guess points to said first search function and said second search function, each search point or guess point will find matches in memory, the steps comprising:
(a) if matches are successful or within a success threshold, modify initial encapsulated tree by increasing the powerpoints and priority percent of visual object/s involved in successful search;
(b) if matches are not successful or within an unsuccessful threshold, try a new alternative visual object search and modify initial encapsulated tree by decreasing the powerpoints and priority percent of visual object/s involved in unsuccessful search;
(c) if alternative visual object search is a better match than the original visual object match modify initial encapsulated tree by deleting the original visual object and replacing it with said alternative visual object.

14. A method of claim 7, wherein each search point comprises radius points, said radius points are equally spaced out points that can have 1 or more copies of itself to triangulate a match area, the steps to triangulate a match area comprising:
(a) designate a visual object in said initial encapsulated tree to search for;
(b) determine the amount of radius points to use for the search;
(c) match each radius point with a memory object and triangulate an optimal memory object to compare;
(d) compare said visual object with optimal memory object and output a match percent.

15. A method of claim 7, wherein each search point or guess point will execute one or two recursive search threads depending on each search point's or guess point's search results, the steps comprising:
(a) if a search point successfully finds a visual object match in memory execute 2 search threads:
(i) search_point (visual object),
(ii) guess_point (memory object),
else if a search point unsuccessfully finds a visual object match in memory execute 1 search thread:
(iii) search_point (visual object);
(b) if a guess point successfully finds a memory object match in said initial encapsulated tree execute b 2 search threads:
(i) guess_point (memory object),
(ii) search_point (visual object),
else if a guess point unsuccessfully finds a memory object match in said initial encapsulated tree execute 1 search thread:
(iii) guess_point (memory object).

16. A method of claim 1, in which said current pathway forget information by the degrading structure of said initial encapsulated tree, whereby when all child visual objects are forgotten the pixel color of said child visual objects occupied will be replaced with the average pixel color of the parent visual object.

17. A method of claim 1, wherein said universalize pathways comprising the steps of:
(a) self-organizing the 4 data types and bringing pathways closer to one another;
(b) set predefined hierarchical levels based on the strength of similar pathways, said hierarchical levels are percentage matches between two or more pathways;
(c) break up groups of pathways that have too many hierarchical levels into a plurality of similar groups, said pathways in similar groups do not have to be exclusive.

18. A method of claim 17, wherein sequential visual objects in memory encapsulated trees or pathways get stronger and stronger due to training, whereby the strength of said sequential visual objects passes a threshold and all said sequential visual objects belonging to one object is designated as an object floater, said object floater's center point is calculated by the total average normalized point of all image layers and all sequential image layers contained in said object floater.

19. A method of claim 1, wherein hidden data or said hidden objects provide additional information about visual objects in pictures and movie sequences, said hidden data for visual objects comprises:
(a) each image layer has a fixed frame size,
(b) each image layer has a normalization point,
(c) each image layer has a location point in the frame,
(d) each image layer has focus area and eye distance,
(e) each image layer has an overall pixel count,
(f) each image layer has data that summarizes all the pixels that it occupies comprising: pixel color, neutral pixel count, patterns in the pixels, 3-dimensional shape and so forth,
(g) each image layer will have a direction of movement from frame to frame,
(h) each image layer will have coordinate movement in terms of x and y from frame to frame,
(i) each image layer will have relationships to other image layers in said current pathway,
(j) each image layer will have a touch sensor that lights up when it touches another image layer,
(k) each image layer will have a degree of change from one frame to the next,
(l) each image layer will have scaling and rotation data.

20. A method of claim 1, wherein said pattern objects assign meaning to words and sentences using 4 different data types and internal functions built into said artificial intelligent program, said internal functions comprises:
(a) the assignment statement,
(b) modifying data in memory,
(c) using the 4 different data types to find patterns,
(d) determining the existence of an object in our environment,
(e) searching for data in memory,
(f) determining the distance of data in the 3-d environment,
(g) rewinding and fast forwarding in long-term memory to find information,
(h) determining the strength and weakness of data in memory,
(i) a combination of all internal functions mentioned above.
